(19) United States
(12) Patent Application Publication
(10) Pub. No.: US 2007/0018975 A1
(43) Pub. Date: Jan. 25, 2007

(54) Methods and systems for mapping a virtual model of an object to the object

(75) Inventors: Zhu Chuanggui, Singapore (SG); Kusuma Agusanto, Singapore (SG)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, S.p.A., Milano (IT)

(21) Appl. No.: 11/490,713

(22) Filed: Jul. 20, 2006

Related U.S. Application Data
(63) Continuation-in-part of application No. PCT/SG05/00244, filed on Jul. 20, 2005.

(51) Int. Cl. G06T 15/00

(52) U.S. Cl. 345/419

(57) ABSTRACT

Systems, apparati and methods for mapping a virtual model of a real object, such as a body part, to the real object are presented. Such virtual model can be generated, for example, from an imaging scan of the object, for example, using MRI, CT, etc. A camera with a probe fixed thereto can be moved relative to the object until a video image of the object captured by the camera appears to coincide on a video screen with the virtual model which is shown fixed on that screen. The position of the camera in a real coordinate system can be sensed, and the position in a virtual coordinate system of the virtual model relative to a virtual camera, by which the view of the virtual model on the screen is notionally captured, can be predetermined and known. From this, the position of the virtual model relative to the object can be mapped and a transform generated to position the object in the virtual coordinate system to approximately coincide with the virtual model. After completion of such an initial registration process, a second, refined, registration process can be initiated. Such refined registration process can include acquiring a large number of real points on the surface of the object. Such points can, for example, then be processed using an iterative closest point measure to generate a second, more accurate transform between the object and its virtual model. Further, the refined registration processing can be iterated and more and more accurate transforms generated until a termination condition is met and a final transform generated. Using the final transform generated by this process the virtual model can be positioned in the real coordinate system to substantially exactly coincide with the object.

### CROSS REFERENCE TO RELATED APPLICATIONS

This application is a continuation-in-part of and claims priority to and the benefit of International Patent Application No. PCT/SG2005/00244, filed on Jul. 20, 2005 in Singapore (and which designated the United States of America).

### TECHNICAL FIELD

The present invention relates to augmented reality systems. In particular, the present invention relates to systems and methods for mapping the position of a virtual model of an object in a virtual coordinate system to the position of such object in a real coordinate system.

### BACKGROUND OF THE INVENTION

Imaging modalities such as, for example, magnetic resonance imaging (MRI) and computerized axial tomography (CAT) allow three-dimensional (3-D) images of real world objects, such as, for example, bodies or body parts of patients, to be generated in a manner that allows those images to be viewed and manipulated using a computer. For example, it is possible to take a MRI scan or a CAT scan of a patient's head, and then to use a computer to generate a 3-D virtual model of the head from the imaging modality and to display views of the model. The computer may be used to seemingly rotate the 3-D virtual model of the head so that it can be seen from another point of view; to remove parts of the model so that other parts become visible, such as removing a part of the head to view more closely a brain tumor, and to highlight certain parts of the head, such as soft tissue, so that those parts become more visible. Viewing virtual models generated from scanned data in this way can be of considerable use in various applications, such as, for example, in the diagnosis and treatment of medical conditions, and in particular in preparing for and planning surgical operations. For example, such techniques can allow a surgeon to decide upon the point and direction from which he or she should enter a patient's head to remove a tumor so as to minimize damage to surrounding structure. Or, for example, such techniques can allow for the planning of oil exploration using 3-D models of geological formations obtained via remote sensing.

International Publication No. WO-A1-02/100284 discloses an example of apparatus which may be used to view in 3-D and to manipulate virtual models produced from an MRI scan, CAT scan or other imaging modality. Such apparatus is manufactured and sold under the name DEXTROSCOPE™ by the proprietors of the invention described in WO-A1-02/100284, who are also the proprietors of the invention described herein.

Virtual Models produced from MRI and CAT imaging can also be used during surgery itself. For example, it can be useful to provide a video screen that provides a surgeon with real time video images of a part or parts of a patient's body, together with a representation of a corresponding virtual model of that part or parts superimposed thereon. This can enable a surgeon to see, for example, sub-surface structures shown in views of the virtual model positioned correctly with respect to the real time video images. It is as if the real time video images can see below the surface of the body part in a bind of “X-Ray vision”. Thus, a surgeon can have an improved view of the body part and may consequently be able to operate with more precision.

An improvement of this technique is described in WO-A1-2005/000139 which has a common applicant with the present invention. In WO-A1-2005/000139 augmented reality systems and methods are described. There, inter alia, an exemplary apparatus, called a “camera-probe” that includes a camera integrated with a hand held probe is disclosed. The position of the camera within a 3-D coordinate system is traceable by tracking means, with the overall arrangement being such that the camera can be moved so as to display on a video display screen different views of a body part, but with a corresponding view of a virtual model of that body part being displayed thereon.

In order for an arrangement such as that described in WO-A1-2005/000139 to work, it will be appreciated that it is necessary to achieve some sort of registry between images of the virtual model and the real time video images. In fact, United States Published Patent Application No. 2005/0215879 A1 (“the Accuracy Evaluation application”), assigned to the proprietor of the present invention, describes various methods for measuring the accuracy of just such a registry by measuring the “overlay error.” This application describes various sources of the overlay error, a prominent one being co-registration error. The disclosure of United States Published Patent Application No. 2005/0215879 A1 is thus hereby incorporated herein by this reference in its entirety.

For accurate co-registration between the real object and a virtual image of such an object, a way is needed of mapping the virtual model, which exists in a virtual coordinate system inside a computer, to the real object of which it is a model, said real object existing in a real coordinate system in the real world. This can be done in a number of ways. It may, for example, be carried out as a two-stage process. In such a process, an initial alignment can be carried out that substantially maps the virtual model to the real object. Then, a refined alignment can be carried out which aims to bring the virtual model into complete alignment with the real object.

One way of carrying out such an initial registration is to fix to a patient's body a number of markers, known as “fiducials”. In the example of a human head, fiducials in the form of small spheres can be fixed to the head such as by screwing them into the patient's skull. Such fiducials can be fixed in place before imaging and can thus appear in the virtual model produced from the scan. Tracking apparatus can then be used to track a probe that is brought into contact with each fiducial in, for example, an operating theatre to record the real position of that fiducial in a real coordinate system in the operating theatre. From this information, and as long as the patient's head remains still, the virtual model of the head can be mapped to real head.

A clear disadvantage of this initial alignment technique is the need to fix fiducials to a patient. This is an uncomfortable experience for the patient and a time-consuming operation for those fitting the fiducials.

An alternative approach for achieving such an initial registration is to specify a set of points on a virtual model produced from the imaging scan. For example, a surgeon or a radiographer might use appropriate computer apparatus, such as the DEXTROSCOPE™ referred to above, to select easily-identifiable points, referred to as “anatomical landmarks”, of the virtual model that correspond to points on the surface of the body part. These selected points can fulfill a similar role to that of the fiducials described above. A user selecting such points might, for example, select on a virtual model of a human face the tip of the nose and each ear lobe as anatomical landmarks. In the operating theatre, a surgeon could then select the same points on the actual body part that correspond to the points selected on the virtual model and communicate the 3-D location of these points in the a real world co-ordinate system to a computer. It is then possible for a computer to map the virtual model to the real body part.

A disadvantage of this alternative approach to the initial registration is that the selection of points on the virtual model to act as anatomical landmarks, and the selection of the corresponding points on the patient, is time consuming. It is also possible that either the person selecting the points on the virtual model, or the person selecting the corresponding points on the body, may make a mistake. There are also problems in determining precisely points such as the tip of a person's nose and the tip of an ear lobe.

What is needed in the art are improved systems and methods for co-registration of a virtual image of an object to the actual position of such object.

### SUMMARY OF THE INVENTION

Systems, apparati and methods for mapping a virtual model of a real object, such as a body part, to the real object are presented. Such virtual model can be generated, for example, from an imaging scan of the object, for example, using MRI, CT, etc. A camera with a probe fixed thereto can be moved relative to the object until a video image of the object captured by the camera appears to coincide on a video screen with the virtual model which is shown fixed on that screen. The position of the camera in a real coordinate system can be sensed, and the position in a virtual coordinate system of the virtual model relative to a virtual camera, by which the view of the virtual model on the screen is notionally captured, can be predetermined and known. From this, the position of the virtual model relative to the object can be mapped and a transform generated to position the object in the virtual coordinate system to approximately coincide with the virtual model. After completion of such an initial registration process, a second, refined, registration process can be initiated. Such refined registration process can include acquiring a large number of real points on the surface of the object. Such points can, for example, then be processed using an iterative closest point measure to generate a second, more accurate transform between the object and its virtual model. Further, the refined registration processing can be iterated and more and more accurate transforms generated until a termination condition is met and a final transform generated. Using the final transform generated by this process the virtual model can be positioned in the real coordinate system to substantially exactly coincide with the object.

### BRIEF DESCRIPTION OF THE DRAWINGS

FIG. 1 depicts a schematic of an exemplary apparatus according to an exemplary embodiment of the present invention;

FIG. 2 depicts a simplified representation of an exemplary real world object;

FIG. 3 depicts a simplified representation of an exemplary virtual model of the object of FIG. 2;

FIG. 4 depicts the representation of the virtual model in a virtual coordinate system, with a point of the image being selected;

FIG. 5 depicts a portion of the exemplary apparatus that can be located in an operating theatre, at the beginning of an initial alignment procedure according to an exemplary embodiment of the present invention;

FIG. 6 depicts the apparatus of FIG. 5 later in the initial alignment procedure according to an exemplary embodiment of the present invention;

FIG. 7 depicts the apparatus of FIGS. 5 and 6 at the completion of the initial alignment procedure according to an exemplary embodiment of the present invention;

FIG. 8 depicts a video screen and a camera probe of the exemplary apparatus during a refined alignment procedure according to an exemplary embodiment of the present invention;

FIG. 9 depicts exemplary real and virtual images displayed as on a video screen at the completion of a refined alignment procedure according to an exemplary embodiment of the present invention;

FIG. 10 depicts an exemplary overall process flow according to an exemplary embodiment of the present invention;

FIG. 11 depict an exemplary phantom of a human head and its virtual image, used to illustrate an exemplary embodiment of the present invention;

FIG. 12 illustrates selection of a point on the virtual image of FIG. 11B according to an exemplary embodiment of the present invention;

FIG. 13 depicts exemplary apparatus and phantom as arranged at the beginning of an alignment procedure according to an exemplary embodiment of the present invention;

FIG. 14 depicts an exemplary initial state of an exemplary virtual image and video image of the corresponding real object according to an exemplary embodiment of the present invention;

FIG. 15 depicts a completed initial alignment of the virtual image and video image of FIG. 14;

FIG. 16 depicts an exemplary refined registration procedure according to an exemplary embodiment of the present invention;

FIG. 17 depicts the virtual and real images of FIG. 14 after the completion of an exemplary refined registration process according to an exemplary embodiment of the present invention;

FIG. 18 is an exemplary process flow for processing data points acquired in a refined registration process iterative closest point measure according to an exemplary embodiment of the present invention;

FIGS. 19-22 depict an exemplary sequence of screen shots according to an exemplary embodiment of the present invention; and

FIG. 23 depicts the video image of the exemplary phantom of FIG. 11A and virtual images of exemplary phantom interior objects after an exemplary refined registration has occurred according to an exemplary embodiment of the present invention.

It is noted that the patent or application file contains at least one drawing executed in color. Copies of this patent or patent application publication with color drawings will be provided by the U.S. Patent Office upon request and payment of the necessary fee.

### DETAILED DESCRIPTION OF THE INVENTION

In exemplary embodiments of the present invention a model of an object, such model being a virtual model positioned in a virtual 3-D coordinate system in virtual space, can be substantially mapped to the position of the (actual) object in a real 3-D coordinate system in real space. For ease of illustration, such a mapping may also be referred to herein as “registration” or “co-registration.”

In exemplary embodiments of the present invention, an initial registration can be carried out which can then be followed by a refined registration. Such initial registration can be carried out using various methods. Once the initial registration has been accomplished, a refined registration can be performed to more closely align the virtual model of the object (sometimes referred to herein as the “virtual object”) with the real object. One method of doing this is, for example, to select a number of spaced-apart points on the surface of the real object. For example, a user can place a probe on the surface of the real object (such as, for example, a human body part) and have a tracking system record the position of the probe. This can be repeated, for example, until a sufficient number of points on the surface of the real object have been recorded to allow an accurate mapping of the virtual model of the object to the real object through a refinement registration.

In exemplary embodiments of the present invention such a process can, for example, include:

a) a computer processing means accessing information indicative of the virtual model;

b) the computer processing means displaying on a display means a virtual image that is a view of at least part of the virtual model, the view being as if from a virtual camera fixed in the virtual coordinate system; and also displaying on the display means real video images of the real space captured by a real video camera moveable in the real coordinate system; wherein the real video images of the object at a distance from the camera in the real coordinate system are shown on the display means as being substantially the same size as the virtual image of the virtual model when the virtual model is at that same distance from the virtual camera in the virtual coordinate system;

c) the computer processing means receiving an input indicative of the camera having been moved in the real coordinate system into a position in which the display means shows the virtual image of the virtual model in virtual space to be substantially coincident with the real video images of the object in real space;

d) the computer processing means communicating with sensing means to sense the position of the camera in the real coordinate system;

e) the computer processing means accessing model position information indicative of the position of the virtual model relative to the virtual camera in the virtual coordinate system;

f) the computer processing means responding to the input to ascertain the position of the object in the real coordinate system from the sensed position of the camera sense in (d) and the model position information of (e); and then mapping the position of the virtual model in the virtual coordinate system substantially to the position of the object in the real coordinate system.

This method can, for example, allow a user to perform an initial alignment between a 3-D model of an object and the actual object in a convenient manner. For example, the virtual image of the 3-D model can appear on the video display means and can be arranged so as not to move on those means when the camera is moved. By moving the real camera, however, real video images of objects in the real space may move across the display means. Thus, a user can, for example, move the camera until the virtual image appears on the display means to coincide with the real video images of the object as seen by the real camera. For example, where the virtual image is of a human head, a user may look to align prominent and easily-recognizable features of the virtual image shown on the display means, such as ears or a nose, with the corresponding features in the video images captured by the camera. When this is done, the input to the computer processing means can fix the position of the virtual image relative to the head.

Such an object can be, for example, all or part a human or animal body, or for example, any object for which a virtual image of said object is sought to be registered to it for various purposes and/or applications, such as, for example, augmented reality applications, or applications where prior obtained imaging data (as may be processed in a variety of ways, such as, for example, by creating or generating a volumetric or other virtual model of the object or objects) is used in conjunction with real-time imaging data of the same object or objects.

In exemplary embodiments of the present invention, the method may include positioning at least one of the virtual model and the object such that they are substantially coincident in one of the coordinate systems. In exemplary embodiments of the present invention the mapping can include generating a transform that maps the position of the virtual model to the position of the object. The method can, for example, further include subsequently applying the transform to position the object in the virtual coordinate system so as to be substantially coincident with the virtual model in the virtual coordinate system. Alternatively, the method can include subsequently applying the transform to position the virtual model in the real coordinate system so as to be substantially coincident with the object in the real coordinate system.

Such a transform can, in general, be written in the form of:
P′=M·P
where P′ is the new pose and P is the old pose, and where M is a 4×4 matrix containing rotation and translation (but no scaling) since it is a rigid-body registration. Specifically, M can contain, for example, a R matrix (a 3×3 rotation matrix) and a T matrix (a 3×1 translation matrix).

In exemplary embodiments of the present invention, such method may include positioning the virtual model relative to the virtual camera in the virtual coordinate system so as to be a predefined distance from the virtual camera. Positioning the virtual model may also include orientating the virtual model relative to the virtual camera. Such positioning can include, for example, selecting a preferred point of the virtual model and positioning the virtual model relative to the virtual camera such that the preferred point is at the predefined distance from the virtual camera. Preferably the preferred point is on the surface of the virtual image. Preferably the preferred point substantially coincides with a well-defined point on the surface of the object. The preferred point may be an anatomical landmark. For example, the preferred point may be the tip of the nose, the tip of an ear lobe or one of the temples. Orientating can include, for example, orientating the virtual model such that the preferred point can be, for example, viewed by the virtual camera from a preferred direction. Positioning and/or orientating can thus be performed, for example, automatically by the computer processing means, or can be carried out by a user operating the computer processing means. In exemplary embodiments of the present invention a user can specify a preferred point on the surface of the virtual model. In exemplary embodiments of the present invention, the user can specify a preferred direction from which the preferred point can be viewed by the virtual camera. In exemplary embodiment of the present invention, the virtual model and/or the virtual camera can be automatically positioned such that the distance there between is the predefined distance.

The method can include, for example, subsequently displaying on the video display means real images of the real space captured by the real camera, and virtual images of the virtual space as if captured by the virtual camera, the virtual camera being moveable in the virtual space with movement of the real camera in the real space such that the virtual camera is positioned relative to the virtual model in the virtual coordinate system in the same way as the real camera is positioned relative to the object in the real coordinate system. The method may therefore include the computer processing means communicating with the sensing means to sense the position of the camera in the real coordinate system. The computer processing means can then, for example, ascertain therefrom the position of the real camera relative to the object. The computer processing means can then, for example, move the virtual camera in the virtual coordinate system so as to be at the same position relative to the virtual model.

By relating movement of the virtual camera with the movement of the real camera in this way, the real camera can be moved so as to display real images of the object on the display means from a different point of view and the virtual camera will be moved correspondingly such that corresponding virtual images of the virtual model from the same point of view are also displayed on the display means. Thus, in exemplary embodiments of the present invention, a surgeon in an operating theatre can, for example, view a body part from many different directions and have the benefit of seeing a scanned image of that part overlaid on real video images thereof.

In exemplary embodiments of the present invention mapping apparatus can be provided for mapping a model of an object, the model being a virtual model positioned in a virtual 3-D coordinate system in virtual space, substantially to the position of the object in a real 3-D coordinate system in real space;

wherein the apparatus includes computer processing means, a video camera and video display means;

the apparatus can be arranged such that: the video display means is operable to display real video images captured by the camera of the real space, the camera being moveable within the real coordinate system; the computer processing means is operable to display also on the video display means a virtual image that is a view of at least part of the virtual model, the view being as if from a virtual camera fixed in the virtual coordinate system,

wherein the apparatus can further include sensing means to sense the position of the video camera in the real coordinate system and to communicate camera position information indicative of this to the computer processing means, and the computer processing means can be arranged to access model position information indicative of the position of the virtual model relative to the virtual camera in the virtual coordinate system and to ascertain from the camera position information and the model position information the position of the object in the real coordinate system, and

wherein the computer processing means can be arranged to respond to an input indicative of the camera having been moved in the real coordinate system into a position in which the video display means shows the virtual image of the virtual model in virtual space to be substantially coincident with a real video image of the object in real space by mapping the position of the virtual model in the virtual coordinate system substantially to the position of the object in the real coordinate system.

The computer processing means can, for example, be arranged and programmed to carry out the method described above.

Such computer processing means can include, for example, a navigation computer processing means for, for example, positioning in an operating theatre for use in preparation for, or during, a medical operation. Such computer processing means can, for example, include planning computer processing means to receive data generated by a body scanner, to generate the virtual model therefrom and to display that image and allow manipulation thereof by a user.

In exemplary embodiments of the present invention, the real camera can include a guide fixed thereto and arranged such that when the real camera is moved such that the guide contacts the surface of the object, the object can be at a predefined distance from the real camera that is known to the computer processing means. The guide can be, for example, an elongate probe that projects in front of the real camera, as described, for example, in WO-A1-2005/000139.

In exemplary embodiments of the present invention, the specification and arrangement of the real camera can be such that, when the object is at the predefined distance from the real camera, the size of the real image of that object on the display means is the same as the size of the virtual image displayed on those display means when the virtual model is at the predefined distance from the virtual camera. For example, the position and focal length of a lens of the real camera may be selected such that this is the case. Alternatively, or additionally, the computer processing means can be programmed such that the virtual camera has the same optical characteristics as the real camera such that the virtual image displayed on the display means when the virtual model is at the predefined distance from the virtual camera appears the same size as real images of the object at the predefined distance from the real camera.

Such camera characteristics can include, for example, focal length, center of image projection, and camera distortion coefficients. Such characteristic values can be specified (programmed) into a camera model, such as, for example, the OpenGL camera model. In doing so, such a camera model can approximate such a real camera.

The mapping apparatus can be arranged, for example, such that the computer processing means can receive an output from the real camera indicative of the images captured by that camera and such that the computer processing means can display such real images on the video display means.

The apparatus may include input means operable by the user to provide the input indicative of the camera having been the position in which the video display means shows the virtual image to be substantially coincident with the real image of the object. The input means may be a user-operated switch. Preferable the input means is a switch that can be placed on the floor and operated by the foot of the user.

In exemplary embodiments of the present invention, a model of an object, the model being a virtual model positioned in a 3-D coordinate system in space, can be more closely aligned with the real object in the real coordinate system, the virtual model and the object having already been substantially aligned, in an initial alignment, as described above, the method including:

a) computer processing means receiving an input indicating that a real data collection procedure should begin;

b) the computer processing means communicating with sensing means to ascertain the position of a probe in the real coordinate system, and thereby the position of a point on the surface of the object when the probe is in contact with that surface;

c) the computer processing means responding to the input to record automatically and at intervals respective real data indicative of each of a plurality of positions of the probe in the real coordinate system, and hence indicative of each of a plurality of points on the surface of the object when the probe is in contact with that surface;

d) the computer processing means calculating a refined transform that substantially maps the virtual model to the real data.

e) the computer processing means applying the transform to more closely align the virtual model with the object in the coordinate system.

In exemplary embodiments of the present invention, a refined transform calculation process can be implemented using the following pseudocode:
1. For each point in the real data, find the nearest point in the model data;
   This set of nearest model point, together with the associated real data point, is called the corresponding point pair.
2. For a given set of corresponding point pairs, compute the transformation such that after transformation, the respective real points are closest to their corresponding paired model points;
   (This computation is known as a procuresses analysis (which is a technique for analyzing statistical distribution of shapes). A seminal paper on this type of analysis is K. S. Arun, T. S. Huang and S. D. Blostein, Least Square Fitting of Two 3-D Point Sets, IEEE Transactions on Pattern Analysis and Machine Intelligence, Vol. PAMI-9, No. 5, September 1987, pp. 698.)
   Transform each point in the real data with the computed transformation, such transformation being expressed by the transformation equation provided above, i.e., P′=M·P; and
3. Repeat processes 1 through 4 until a termination condition is met. Such a termination condition can be, for example, the number of iterations being equal to a system defined maximum number of iterations, or, for example, the root mean square distance (RMS error) between the real and virtual points being less than a pre-defined minimum RMS error, or, for example, some combination of both such conditions.

Thus, obtaining such a transform can be thought of as a repeated operation. I.e., the new transform can be applied to generate a new object position, and the new object position can then be used to generate a new transform, etc.

In exemplary embodiments of the present invention, in (c) above, the method can, for example, record respective real data indicative of each of at least 50 positions of the probe and can record, for example, respective real data indicative of each of 100, 200, 300, 400, 500, 600, 700 or 750 (or any number of points in between) positions of the probe.

In exemplary embodiments of the present invention, real data indicative of the position of the probe can be indicative of the position of a tip of the probe that can be used to contact the object. In exemplary embodiments of the present invention, the computer processing means can automatically record the respective real data such that the position of the probe (and thus of its tip) at periodic intervals is recorded. In exemplary embodiments of the present invention, the method can, for example, include the step of the computer processing means displaying on the video display means one, more or all of the positions of the probe for which real data is recorded. In exemplary embodiments of the present invention, the method can include displaying the positions of the probe together with the virtual model to show the relative positions thereof in the coordinate system. In exemplary embodiments of the present invention, the method displays each position of the probe substantially as the respective data indicative thereof is collected. In exemplary embodiments of the present invention, each position of the probe can be displayed in this manner in real time.

In exemplary embodiments of the present invention, a method for initial registration can, for example, also additionally include the refined registration method just described.

Additionally, in exemplary embodiments of the present invention, the mapping apparatus may be further programmed and arranged to implement such refined registration.

In exemplary embodiments of the present invention, there can be provided a computer processing means arranged and programmed to carry out one or more of the methods.

Such a computer processing means can include a personal computer, workstation or other data processing device as is known in the art.

In exemplary embodiments of the present invention, a computer program can be provided that includes code portions which are executable by a computer processing means to cause those means to carry out one or more of the methods described above.

In exemplary embodiments of the present invention, a record carrier can be provided, including therein a record of a computer program having code portions which are executable by computer processing means to cause those means to carry out one or more of the methods described above.

Such a record carrier can be, for example, a computer-readable record product, such as one or more of: an optical disk, such as a CD-ROM or DVD; a magnetic disk or storage medium, such as a floppy disk, flash memory, memory stick, portable memory, etc.; or solid state record device, such as an EPROM or EEPROM. The record carrier can be a signal transmitted over a network. Such a signal can be an electrical signal transmitted over wires, or a radio signal transmitted wirelessly. The signal can be an optical signal transmitted over an optical network.

It will be appreciated that references herein to the “position” of items such as the virtual model, the object, the virtual camera and the real camera are references to both the location and orientation of those items.

Medical Planning/Surgical Navigation Example

In exemplary embodiments of the present invention, a virtual model of a patient stored in a computer, such as that which can be produced as a result of an MRI, CT or other medical imaging modality scan (or, for example, a co-registered combination of both), can be mapped to the position of the actual patient in an operating theatre. This mapping can allow views of the virtual model to be overlaid on real time video images of the patient in a positionally correct manner, and can thus act as a surgical planning and navigational aid. Such an exemplary embodiment is next described. The description will include a description of an initial registration procedure in which a virtual model is substantially mapped to the position of the actual patient, and a refined registration procedure in which the aim is for the virtual model to be substantially exactly mapped to the patient.

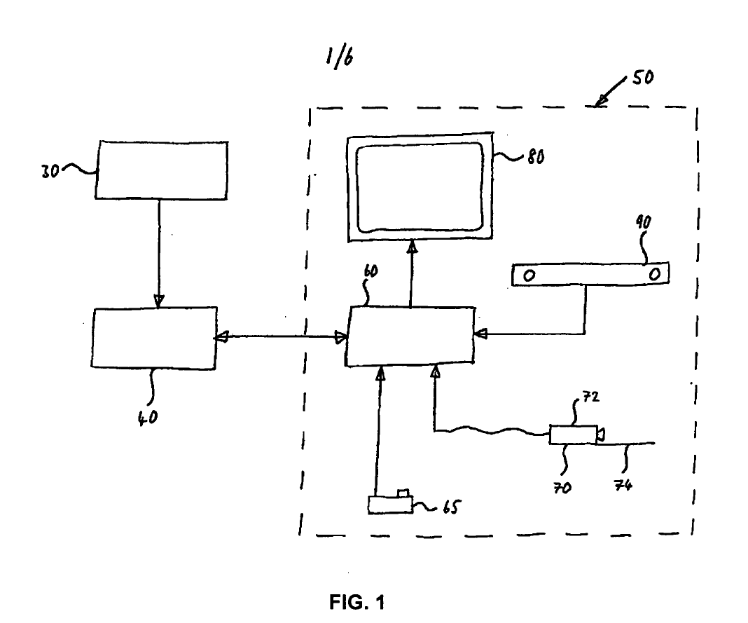

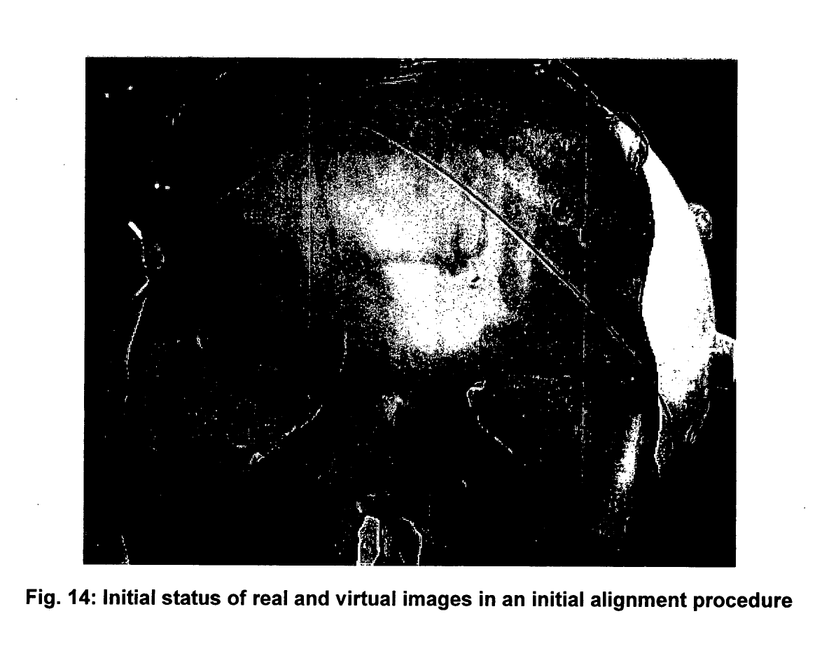

In accordance with exemplary embodiments of the present invention, FIGS. 1-9 depict generalized schematics of exemplary augmented reality apparatus, an exemplary video image of a real object and, an exemplary virtual image of that object according to exemplary embodiments of the present invention. Additionally, FIGS. 11-23 are actual images of an actual implementation of an exemplary neurosurgical planning/neurosurgical navigation embodiment of the present invention. Thus both schematic FIGS. 1-9 and actual images FIGS. 11-23 will be referred to in the description that follows.

FIG. 1 shows, in schematic form, exemplary augmented reality system apparatus 20. Apparatus 20 includes an MRI scanner 30 which is in data communication with planning station computer 40. MRI scanner 30 can be, for example, arranged to perform an MRI scan of a patient and to send data generated by that scan to planning station computer 40. Planning station computer 40 can be arranged to produce a 3-D model of the patient from the scanned data that can be viewed and manipulated by an operator of the planning station computer 40, such as, for example, a radiographer or a neurosurgeon. As the 3-D model exists only inside the computer, it will be referred to herein as a “virtual model”.

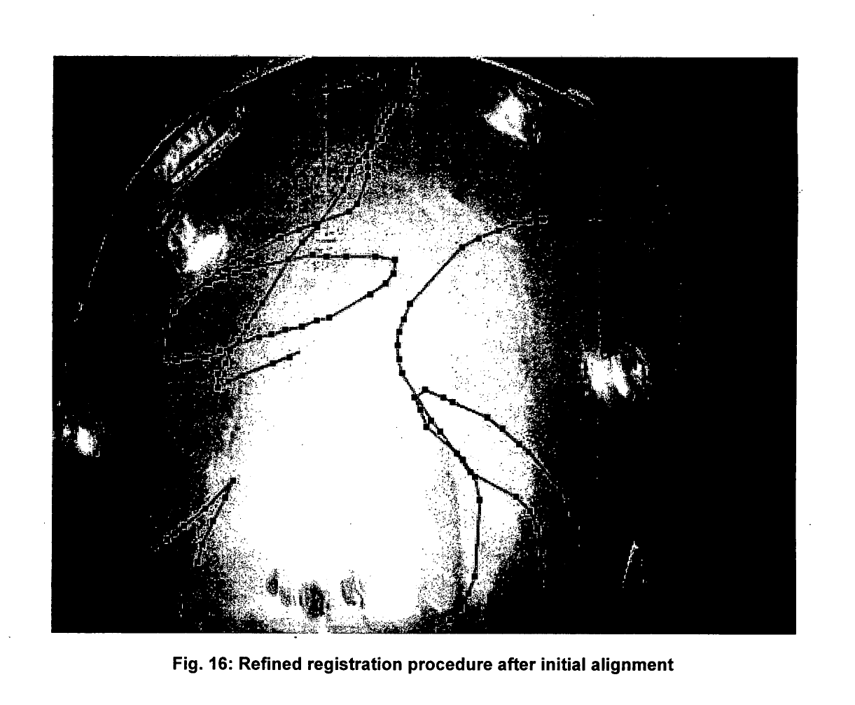

Similarly, FIG. 13 depicts an exemplary actual surgical navigation apparatus including a tracking system (shown at the upper right of the figure), a display (shown at the left-center), a phantom head (at the bottom left), and a user holding a camera-probe (an example of the device described in WO-A1-2005/000139) near the phantom head at the beginning of an initial alignment procedure.

With continued reference to FIG. 1, apparatus 20 can further include theatre apparatus 50 that can be located in an operating theatre (not shown). Theatre apparatus 50 can include, for example, navigation station computer 60 in data communication with planning station computer 40. Theatre apparatus 50 can further include foot switch 65, camera probe 70, tracking equipment 90 and monitor 80. Foot switch 65 can, for example, be positioned on the floor and communicably connected to navigation station computer 60 so as to provide an input thereto when depressed by the foot of an operator.

Camera probe 70 comprises video camera 72 with a long, thin, probe 74 projecting therefrom into the centre of the field of view of camera 72. Video camera 72 is compact and light such that it can easily be held without strain in the hand of an operator and easily moved within the operating theatre. A video output of camera 72 can be, for example, connected as an input to navigation station computer 60. Tracking equipment 90 can, for example, be arranged to track the position of camera probe 70 in a known manner and can be connected to navigation station computer 60 so as to provide data thereto indicative of the position of camera probe 70 relative thereto. Further details of such exemplary augmented reality apparatus are provided in WO-A1-2005/000139.

In the following example, the part of the patient's body that is of interest is the head. Such an exemplary use could be for neurosurgical planning and navigation, for example. Specifically, it is assumed that an MRI scan has been performed of a patient's head and a 3-D virtual model of the patient's head has been constructed from data gleaned from that scan. The model, which can be viewable on computer means, such as for example, in the form of planning station computer 40, shows, it is further assumed in this example, a tumor in the region of the patient's brain. The intention is that the patient should undergo surgery with a view to removing the tumor, and an augmented reality system used to plan and execute such surgery. Accurate registration or mapping of the virtual model of the head and the real head in an operating theatre is required. Such a mapping can be done according to exemplary embodiments of the present invention.

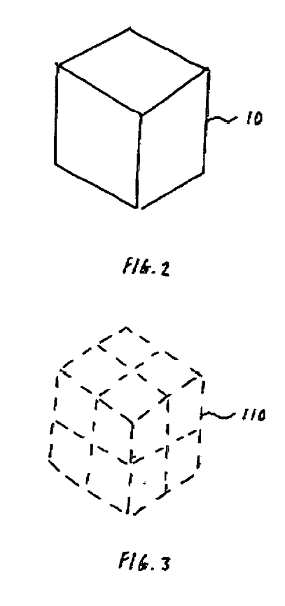

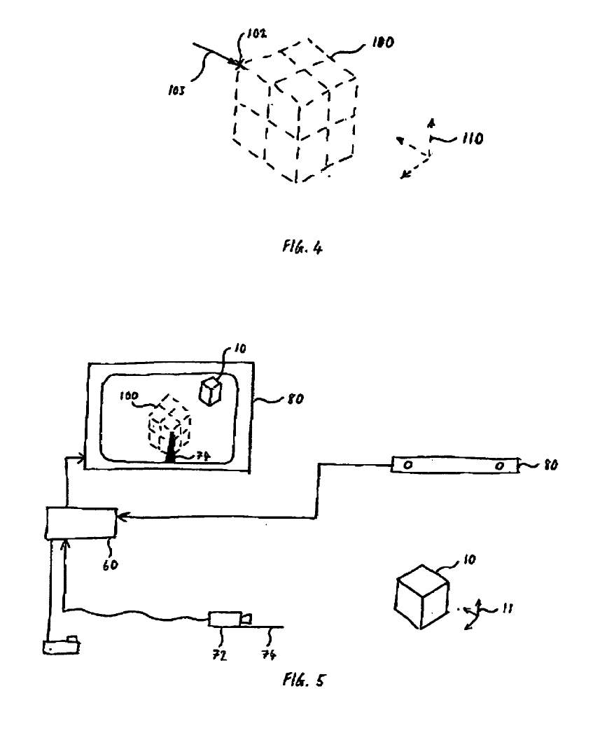

FIGS. 1-9 depict a generalized schematic body part (drawn as a cube 10) and a virtual image of it (drawn as a dashed cube 100). In the following example the generic cube 10 is assumed to be a head, and the virtual cube 100 a virtual model of that head. FIGS. 2 and 3 thus depict head 10 and a virtual model of the head 100. It is understood that the systems and methods of the present invention can be applied to any object and a virtual image of it, and relate to the registration of a virtual image of an object to a real world object, regardless of application.

As a preliminary procedure, an MRI scan can be performed of the patient's head using MRI scanner 30. Scan data from such a scan can be sent from MRI scanner 30 to planning station computer 40. Planning station computer 40 can, for example, run planning software that uses the scan data to create a virtual model that can be viewed and manipulated using planning station computer 40. For example, if planning station computer is a Dextroscope™, planning software can be the companion RadioDexter™ software provided by Volume Interactions Pte Ltd of Singapore. As noted, head 10 is shown in FIG. 2 and virtual model 100 is shown in FIG. 3. Analogously, FIG. 11A is an actual image of a phantom head, and FIG. 11B is a virtual image of it, created from an MRI scan.

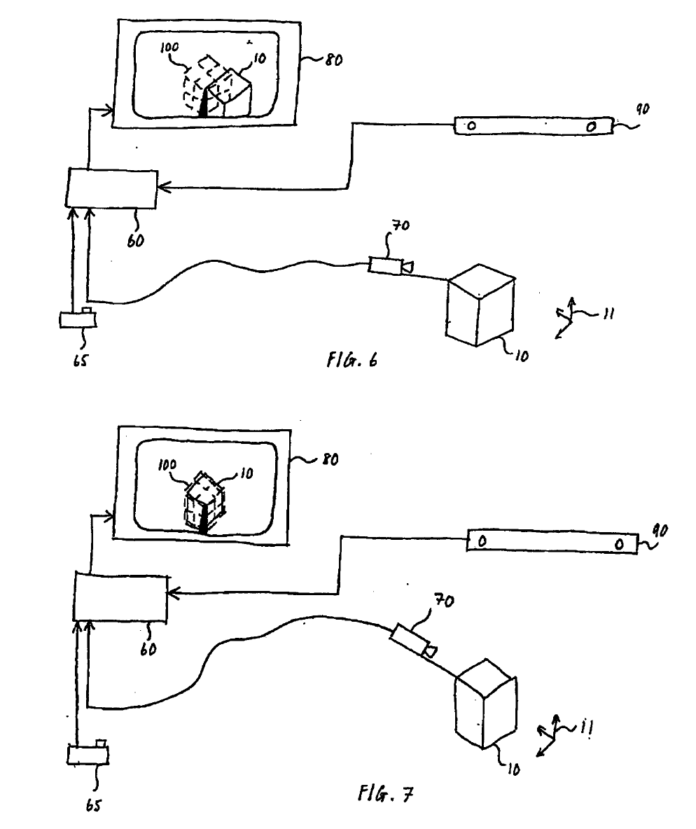

With reference to FIG. 4, virtual model 100 can be made up of a series of data points positioned in a 3-D coordinate system 110 inside, for example, planning station computer 40. As this coordinate system exists only in planning station computer 40 and, as yet, has no frame of reference in the real world, coordinate system 110 will be referred to as “virtual coordinate system” 110 and will be referred to as being in “virtual space.”

By interacting with planning station computer 40 and planning software running thereon, a user can, for example, select a point of view from which virtual model 100 should be viewed in the virtual space. To do this, he can first select a point 102 on the surface of virtual model 100. In exemplary embodiments of the present invention, it is often useful to select a point that is comparatively well defined, such as, in the case of a model of a head, the tip of the nose or an ear lobe. A user can then select a line of sight 103 leading to the selected point. Point 102 and line of sight 103 can then be saved, together with the scanning data from which the virtual model is generated, as virtual model data by the planning software.

An exemplary interface can, for example, use a mouse, first, to adjust the viewpoint of the camera relative to the virtual object in the interface window, and second, by moving the mouse cursor over the model, and clicking the right button on the mouse, a point which is the projection of the cursor point on the model can be found on the surface of the model. Subsequently, this point can be used as a pivot point (described below), and the viewpoint is how the virtual object will appear when displayed in the combined (video and virtual) image.

The virtual model data can be saved, for example, so as to be available to navigation station computer 60. In this exemplary embodiment, the virtual model data can be made available to navigation station computer 60 by virtue of, for example, computers 40, 60 being connected via a local area network (LAN), wide area network (WAN), virtual private network (VPN), or even the Internet, using known techniques.

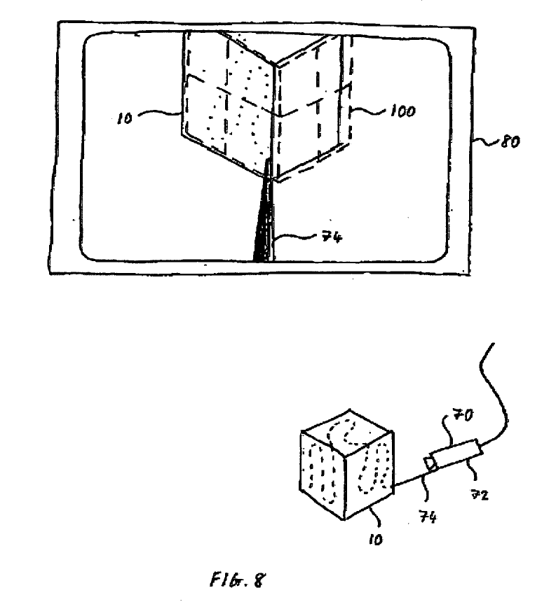

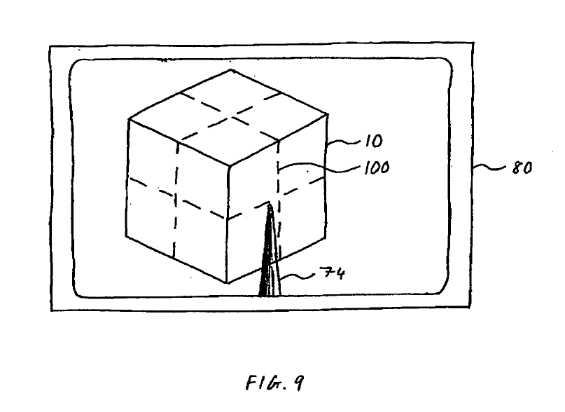

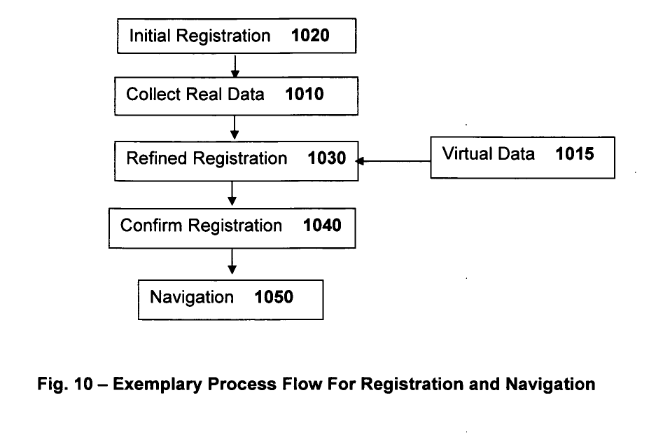

After scanning and creation of the virtual image, activity can then move, for example, to the operating theatre. FIG. 5 depicts a schematic representation of an exemplary operating theatre. The patient can be prepared for surgery and positioned such that his head 10 is fixed in a real coordinate system 11 defined by the position of tracking equipment 90 (in FIG. 5 tracking equipment is mistakenly labeled as “80”; it should actually be labeled “90” as in FIGS. 6-7; Applicant reserves the right to correct FIG. 5 to so reflect). In the operating theatre, a user, such as, for example, a surgeon, can then operate navigation software running on navigation computer station 60 to access the virtual model data saved by planning computer station 40.

With continued reference to FIG. 5, the navigation software can, for example, display virtual model 100 on monitor 80. Virtual model 100 can, for example, be displayed as if viewed by a virtual video camera that is fixed so as to view the virtual model from the point of view specified using planning station computer 40, and at a distance from the virtual camera specified, for example, by the navigation software. Simultaneously, the navigation software, for example, can receive data indicative of real time video output from video camera 72 and can thus display video images corresponding to that output on monitor 80. Such combined display is the augmented reality combined images described in WO-A1-2005/000139 and the Accuracy Evaluation application. For ease of description, such displayed video images will be referred to as “real images” and video camera 72 will be referred to as the “real camera” in order to clearly distinguish these from the “virtual” images of virtual model 100 generated by the virtual camera.

The navigation software and real camera 72 can be calibrated such that the displayed image of a virtual model at a distance x in virtual coordinate system 110 from the virtual camera can be shown as the same size on monitor 80 as would be a real image of the corresponding object at a distance x in the real world from real camera 72. In exemplary embodiments of the present invention, this can be achieved because the virtual camera can be specified to have the same characteristics as real camera 72. Additionally, the virtual model can faithfully resemble the real object through acquired scanned images and 3-D reconstruction followed by surface extraction.

It will be understood that references to the distance of an object or model from a camera may more properly be referred to as the distance from the focal plane of that camera. However, for clarity of explanation, reference to focal planes is omitted herein.

Furthermore, the navigation software can be arranged to display images of the virtual model as if the point 102 selected previously were at a distance from the virtual camera that is equal to the distance of the tip of probe 74 from the real camera 72 to which it is attached. (This allows the virtual images to emulate in a sense the real images, as the video camera 72 of camera probe 70 is always that distance from the real object.) Whilst real camera 72 is moveable in the real world such that moving real camera 72 causes different real images to appear on monitor 80, moving real camera 72 has no effect on the position of the virtual camera in virtual coordinate system 110. Thus, the image of virtual model 100 therefore can remain static on monitor 80 regardless of whether or not real camera 72 is moved. As probe 74 is fixed to real camera 72 and projects into the centre of the camera's field of view, probe 72 is also always visible projecting into the centre of the real images shown on monitor 80. As a result of all this, images of virtual model 100 can appear fixed on monitor 80 with point 102 (previously selected) appearing as if fixed at the end of probe 72. This remains the case even when real camera 72 is moved around and different real images pass across the monitor 80.

Thus, it is as if the virtual object is attached to the tip of the real probe, and its relative pose is fixed. As a user places the probe tip on the pivot point and pivots the probe, the virtual object can, for example, be aligned to the real object.

FIG. 5 shows virtual model 100 displayed on monitor 80 and positioned so that the selected point 102 is at the tip of the probe 72, where the view of virtual model 100 is that previously selected using planning stage computer 40, as described above. In the arrangement depicted in FIG. 5, camera probe 70 is some distance from the patient's (real) head 10. As a result, the real image of the head 10 on the monitor is shown as being in the distance (shown at the top right corner of monitor 80 in FIG. 5).

Also visible in FIG. 5 (at the far right of the figure) is tracking equipment 90 (as noted, it is mislabeled in FIG. 5 as “80”). During operation of theatre apparatus 50, the navigation software can receive camera probe position data from tracking equipment 90 that is indicative of the position and orientation of camera probe 70 in real coordinate system 11.

It is noted that the separation of a planning computer and a navigation computer is exemplary only, and moreover, arbitrary. The various functions of acquiring scan data, generating a virtual model, displaying a combined image of a virtual model of an object and a real object using tracking system data regarding a camera probe, and facilitating a user performing an initial registration and a refined registration, can, in exemplary embodiments of the present invention be implemented in any convenient manner, using integrated or distributed apparati, and be respectively implemented in hardware and software or any combination thereof, as may be desired in a given context. The description given here is one of many possible exemplary implementations, all of which are understood as within the scope of the present invention.

Initial Registration

In order to begin an initial registration procedure in which the position of virtual model 100 of a head can be substantially mapped to the position of the patient's real head 10 in real coordinate system 11, a user can, for example, move camera probe 70 towards patient's real head 10. As camera probe 70, which includes real camera 72 (and probe element 74), approaches the patient's real head 10, the real image of head 10 on the monitor grows. The user can then, for example, move camera probe 70 towards the patient's head such that the tip of the probe 74 touches the point on the head 10 that corresponds to the point 102 which was earlier selected on the surface of the virtual model. As noted above, a convenient point might be the tip of the patient's nose.

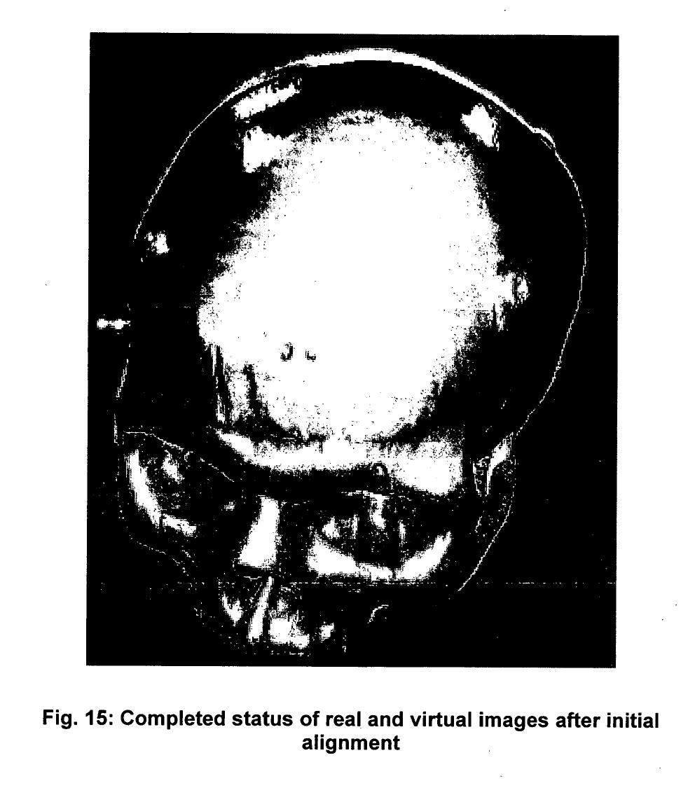

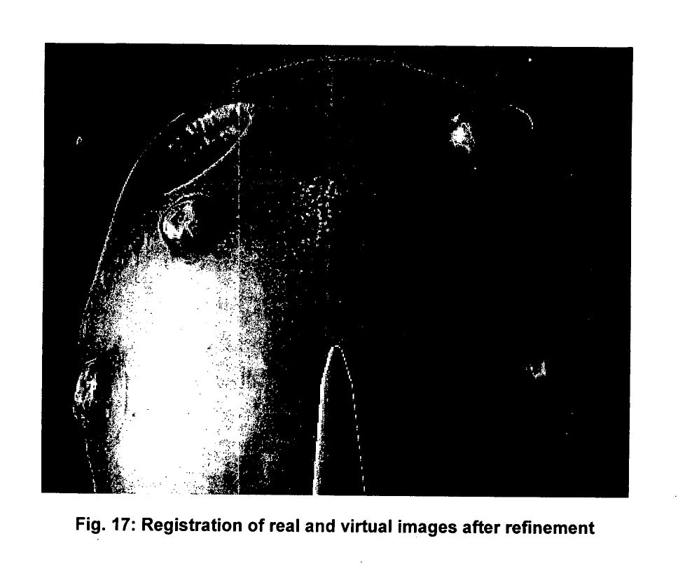

Monitor 80 can then, for example, show a real image of head 10 positioned with the tip of the nose at the tip of the probe 74. This arrangement is shown schematically in FIG. 6, and an analogous actual implementation in FIG. 12, which shows a point selected on the bridge of the nose of the virtual image of the phantom head, shown by a + icon. As the image of virtual model 100 would not have moved from its static position in the display, the tip of the nose on the virtual model 100 can therefore appear to coincide with the tip of the nose on real image of the head 10. As depicted in FIG. 6, the remainder of the virtual model 100 may, however, not coincide with the remainder of the real image, there only being correspondence at point 102. This lack of coincidence is referred to as overlay error, as noted above. An analogous situation is depicted in FIG. 14, where the virtual image (shown at the center of FIG. 14, in an upright position) and the real image (tilted to the right approximately 45° from the virtual image) coincide at the selected point on the bridge of the nose (shown in FIG. 12 by the “+” symbol) but otherwise do not coincide.

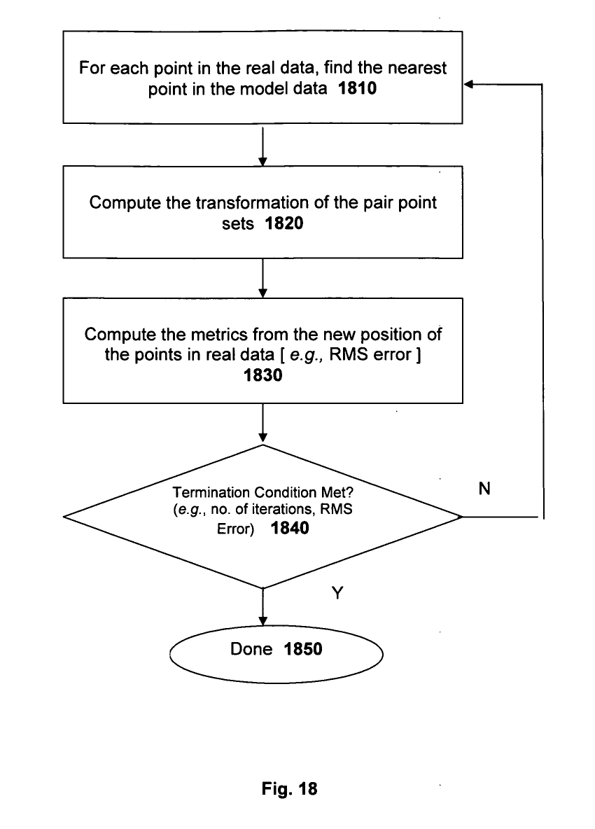

With reference again to FIG. 6, in order to bring the rest of the real image of head 10 into alignment with the image of the virtual model 100, a user can, for example, move the camera around, whilst keeping the tip of the probe on the tip of the patient's nose. By looking at monitor 80, for example, the user can receive visual feedback as to whether or not he is bringing real image 10 into alignment with virtual image 100. Once he has succeeded in achieving the closest alignment that he is able to achieve, such as, for example, that shown in FIG. 7 (and analogously in FIG. 15), where the real and virtual images are substantially aligned, the user can, for example, depress foot switch 65 to signal navigation station computer 60. Thus, foot switch 65 can, for example, send a signal to navigation station computer 60 that can be taken by the navigation software to mean that real image 10 is substantially aligned with virtual image 100. Upon receiving this signal, navigation software can, for example, record the position and orientation of camera probe 70 in real coordinate system 11.

At this point the navigation software knows:
a) that the present position of camera probe 70 results in the real image of head 10 being coincident with virtual image 100 on the monitor; and
b) the arrangement is such that the virtual camera shows on the monitor a virtual image of the object that appears on the monitor to be the same size as the real image of the object captured by the real camera, when each of the virtual model and real object is the same distance from its respective camera; it can thus conclude that the patient's head 10 must be positioned in front of real camera 72 in the same way as virtual image 100 of such head 10 is positioned in front of the virtual camera.

Furthermore, as the navigation software also knows the location and orientation of the virtual model relative to the virtual camera, it can ascertain the location and orientation of the patient's head 10 relative to the real camera 72; and as it also knows the location and orientation of camera probe 70 and hence real camera 72 in the real coordinate system, it can calculate the location and orientation of the patient's head 10 in that real coordinate system.

Upon calculating the location and orientation of head 10 in the real coordinate system, the navigation software can then map the position of the virtual image 100 in the virtual coordinate system to the position of the patient's head 10 in the real coordinate system. The navigation software can, for example, cause the navigation station computer to carry out necessary calculations to generate a mathematical transform that maps between these two positions. That transform can then be applied to position the patient's head in the virtual coordinate system so as to be substantially in alignment with the virtual model of the head therein.

In exemplary embodiments of the present invention, such a transform can be expressed as a multiple transformation, such as, for example,
Pᵢₐ=Mᵢₐ·Pₒₚ,
where Mᵢₐ can be computed from the initial registration transform, Pᵢₐ is the pose after initial alignment, and Pₒₚ is the original pose of the virtual model.

For example, assuming that before the initial alignment process the position of the virtual model was (1.95, 7.81, 0.00) and its orientation matrix [1,0,0,0,1,0,0,0,1].

Assuming further that after an initial alignment process, the position was changed to (192.12, −226.50, −1703.05) and its orientation to

[−0.983144, −0.1742, 0.0555179,

−0.178227, 0.845406, −0.50351,

0.0407763, −0.504918, −0.862204],

then in this example the value for transformation matrix Mᵢₐ can be thus given as:

[−0.983144, −0.1742, 0.0555179, 190.17,

−0.178227, 0.845406, −0.50351, −234.31,

0.0407763, −0.504918, −0.862204, −1703.05, 0, 0, 0, 1].

In exemplary embodiments of the present invention, matrix Mᵢₐ can thus, for example, be computed from: (1) the predefined initial orientation of the virtual camera toward the virtual model; (2) the location of the pivot point in the virtual model; (3) the location of the tip of the probe, which can be known from the tracking data; and (4) the orientation of the probe, which can also be known from the tracking data. Additionally, after a refined registration process, matrix Mᵢₐ can then, for example, be modified to transform matrix M_{rf}, obtained from P_{fp}=M_{rf}·Pᵢₐ, where M_{rf} is the refinement registration transform, and P_{fp} is the final pose.

For example, actual values for M_{rf} can be:

[1, 0, 0, 1.19,

0, 1, 0, −3.30994,

0, 0, 1, −3.65991,

0, 0, 0, 1],

where the final position of the virtual model is, for example, (193.31, −229.81, −1706.71) and its orientation is, for example,

[−0.983144, −0.1742, 0.0555179,

−0.178227, 0.845406, −0.50351,

0.0407763, −0.504918, −0.862204].

In exemplary embodiments of the present invention process flow of the object transformation in the initial alignment can be, for example, as follows: the object is aligned from its initial pose (for example, the pose saved previously from the planning software, as described above with reference to FIG. 4) to the pose after initial alignment. It is noted that here the coordinate system of the virtual model and the real object coordinate system coincide (i.e., they share the same coordinate system). This can happen by, for example, defining in an exemplary computer program that the origin and the axes of the real coordinate system (for example, in the situation described above, the origin of the tracking system) are the same as those of the virtual model.

During initial alignment, there can be, for example, a few intermediate transformation steps, such as, for example, bringing the alignment point on the virtual model (for example, pivot point 102 in FIG. 4) to the tip of the probe (which can be done, for example at the beginning of the alignment), and as the probe is moved by a user, the virtual model can also be constantly moved such that its relative pose is fixed relative to the probe tip (which happens during the alignment itself), and lastly, when alignment is complete, the last location of the probe tip can, for example, determine the pose of the virtual model (and at this moment, the virtual model is no longer attached to the probe tip but stays at its current position in the workspace).

An alternative way of conceptualizing this is to think of the virtual coordinate system becoming fixed relative to the real coordinate system and located and orientated relative thereto such that virtual model 100 coincides with head 10.

After initial alignment, in exemplary embodiments of the present invention, the navigation software, for example, can then unfix the virtual camera from its previously fixed position in the virtual space and fix it to real camera 72 such that it is moveable with real camera 72 through the virtual space as the real camera moves through the real space. In this way, pointing real camera 72 at head 10 from different points of view can result in different real views being displayed on monitor 80, each with a corresponding view of the virtual model overlaid thereon and in substantial alignment therewith. Thus, a user can view the real image as augmented by a virtual one (which can contain hidden parts of the virtual model as well, as described in WO-A1-2005/000139), a desideratum in augmented reality systems.

What has been described thus far completes an exemplary initial alignment procedure according to exemplary embodiments of the present invention. However, it is unlikely that such an initial alignment procedure will result in accurate alignment. Any slight unsteadiness in the hand of a user may lead to imperfect alignment between head 10 and virtual model 100. Inaccurate alignment may also result from difficulty in placing the tip of the probe 74 at the very same point on the patient as was selected using the planning station computer, as described above. In the present example, it may be difficult to locate a single unambiguous point that represents the tip of the nose, or for example, the bridge of the nose as depicted in FIG. 12. Thus, it is likely that following initial registration, there would remain some misalignment between head 10 and virtual model 100, and there is thus an unsatisfactory amount of overlay error, due to registration error. In order to improve the alignment, in exemplary embodiments of the present invention, a procedure of refined registration can, for example, subsequently be carried out.

In general, misalignment after an initial alignment process can range from ±5 to 300 in one or all of the axes (angular misalignment), and from 5 to 20 mm of positional misalignment.

Refined Registration

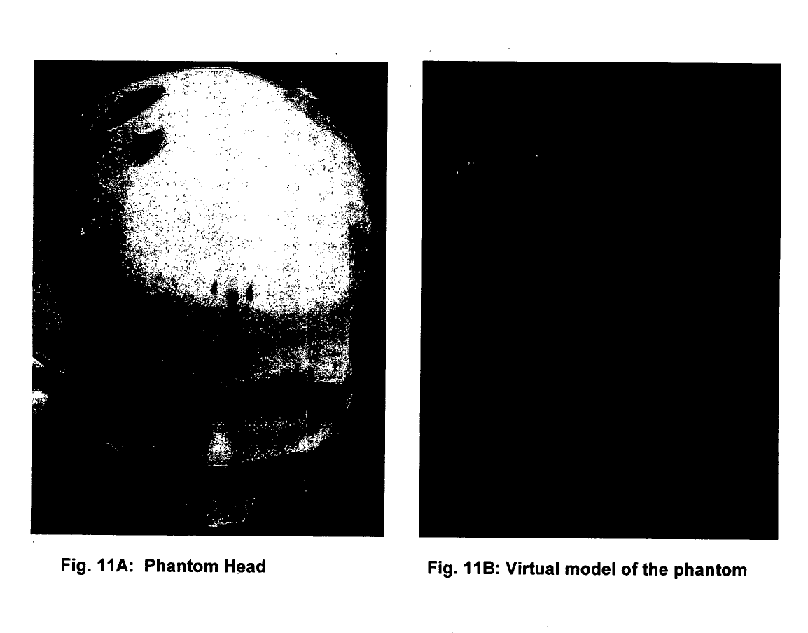

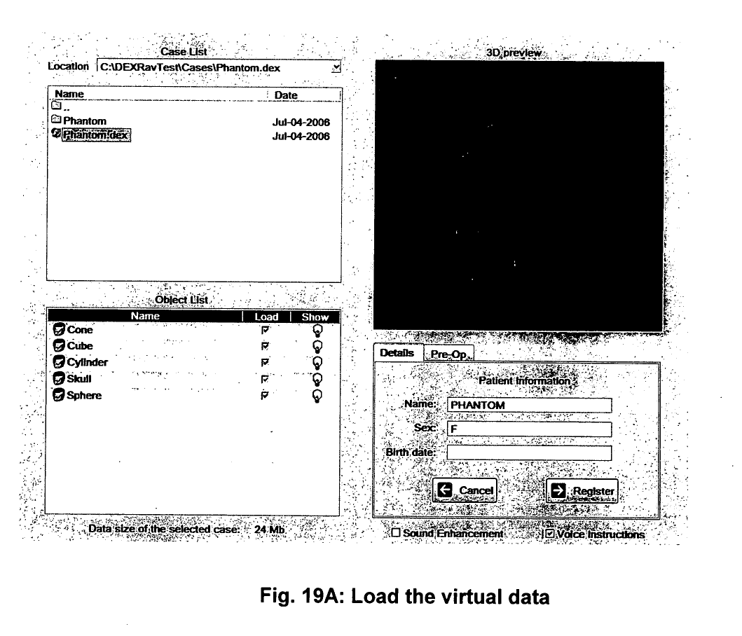

With reference to FIG. 8, a user can begin a refined registration process by indicating to the navigation software that refined registration is to begin. He can then, for example, move camera probe 70, such that the tip of probe 74 traces a route across the surface of head 10. This is also illustrated in FIG. 16, where a user acquires a number of points on the surface of the real phantom head. As can be seen in FIG. 16, the alignment has some error, so at the top of the figure the real phantom head extends somewhat beyond the virtual image of the phantom head. This is due to the overlay now utilizing the mathematical transform obtained form the initial registration process, a refined registration just having begun, with no transform yet having been output. At the same time, the navigation software can, for example, receive data from tracking equipment 90 indicative of the position of camera probe 70, and hence the tip of probe 74, in the real coordinate system.

From this data, and by using the mathematical transform calculated at the end of the initial alignment procedure, the computer can calculate the position of the camera probe, and hence the tip of the probe, in the virtual coordinate system. The navigation software can, for example, be arranged to periodically record position data indicative of the position of each of a series of real points on the surface of the head in the virtual coordinate system. Upon recording a real point, the navigation software can display it on monitor 80, as shown in FIG. 8 (depicting numerous points in a curved line across the surface of real head 10) and similarly in FIG. 16 (points shown in purple color, line traced by probe shown in red). This can help to ensure that a user only moves the tip of probe 74 across parts of the patient that are included in the virtual model and hence for which there is virtual model data. Moving the tip of probe 74 outside the scanned region may reduce the registration accuracy as this would result in a real point being recorded for which there is no corresponding point making up the surface of the virtual model, effectively decreasing the points acquired that are available to use in further processing, or, as described below, causing the system to search for a corresponding virtual point, which is simply not there.

As can be seen in FIG. 8, the tip of probe 74 can, for example, be traced evenly over the surface of a scanned part of the patient's body, in this example head 10. The tracing can continue until the navigation software has collected sufficient data for enough real points. In exemplary embodiments of the present invention, the software can, for example, collect data for 750 real points. After the data for the 750th real point has been collected, the navigation software can notify the user, such as, for example, by causing the navigation station computer to make a sound or trigger some other indicator, and stop recording data for real points.

It will be appreciated that the navigation software now has access to data representing 750 points that are positioned in the virtual coordinate system (using the mathematical transform obtained from the initial alignment to transform real points into points in the virtual coordinate system) so as to be precisely on the surface of head 10.

In exemplary embodiments of the present invention, the navigation software can then access the virtual model data that makes up the virtual model. The software can, for example, isolate the data representing the surface of the patient's head from the remainder of the data. From the isolated data, a cloud point representation of the skin surface of the patient's head 10 can be extracted. Here, the term “cloudpoint” refers to a set of dense 3-D points that define the geometrical shape of the virtual model. In this example, they are points on the surface (or skin) of the virtual model.

In exemplary embodiments of the present invention, the navigation software can next cause the navigation station computer to begin a process of iterative closest point (ICP) measure. In this process, the computer can find, for each of the real points, a closest one of the points making up the cloud point representation.

This can be done, for example, by building a k-d tree of cloud points (a “k-d tree” being a space-partitioning data structure for organizing points in a k-dimensional space, in the described example, k=3) and then computing the distance of the points (e.g. squared distance) in the appropriate structure of the tree and keeping only the lowest value of the distance (nearest points). K-d trees are described in detail in Bentley, J. L., Multidimensional binary search trees used for associative searching, Commun. ACM 18, 9 (Sep. 1975), pp. 509-517.

Once a pair has been established for each of the real points, in exemplary embodiments of the present invention the computer can calculate a transformation that would shift, as closely as possible, each of the paired points of the cloud point representation to the associated real point in the respective pair.

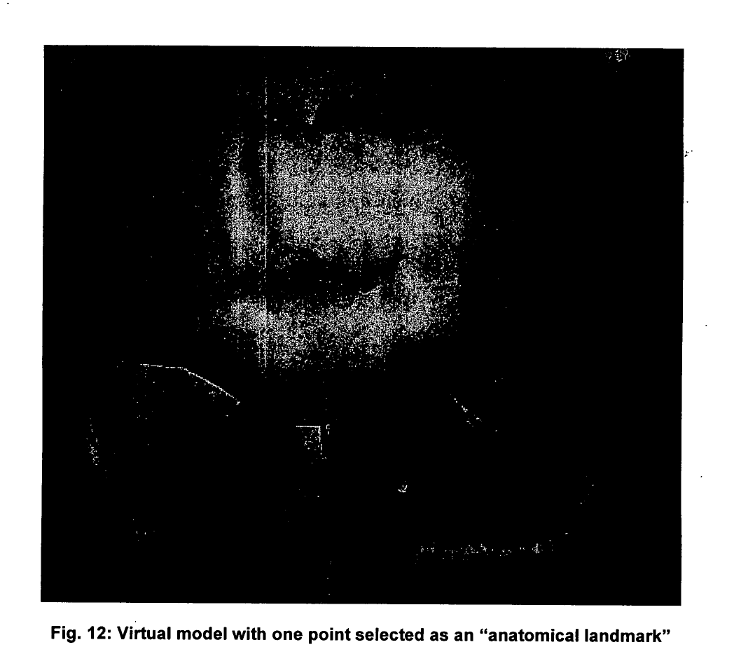

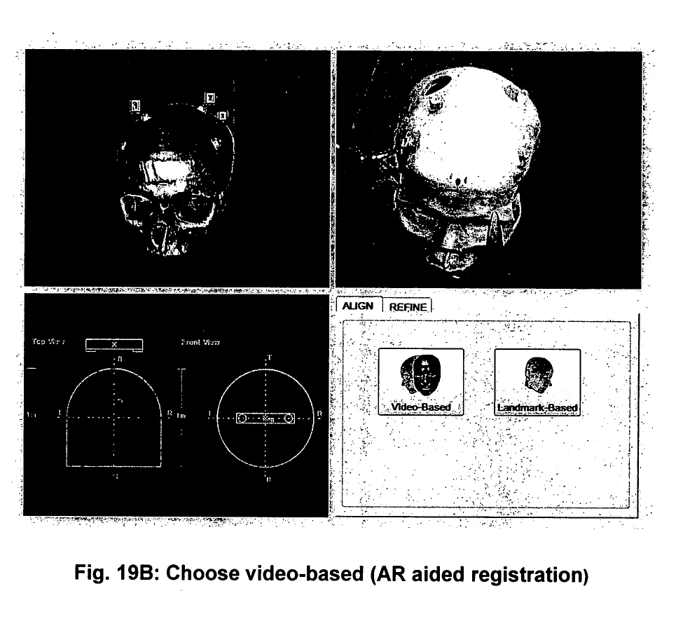

The computer can then, for example, apply this transformation to move the virtual model into closer alignment with the real head in the virtual coordinate system. Once the virtual model has been so moved, the computer can then, for example, repeat the process. For example, the computer can repeat, for the new location of the virtual model relative to the real points, the operation of pairing-off each real point with a corresponding (new) closest point in the cloud point representation, find a transformation that would shift, as closely as possible, each of the (new) paired points of the cloud point representation to its respective associated real point, and then applying that new transformation to again move the virtual model relative to the real object in the virtual co-ordinate system. Subsequent iterations can, for example, be carried out until the position of the virtual model 100 settles into a final position. This can be determined, for example, if the mathematical transform M_{rf} converges to a certain value (convergence being defined as marginal change being less than a certain ratio), or for example, using another metric, such as, for example, the RMS value of the square-distance of cloudpoint pairs between input and model, i.e., the RMS error value being less than a defined value). Such a situation is shown in FIG. 9 and analogously in FIG. 17. The software can then fix the virtual model 100 in such final position.

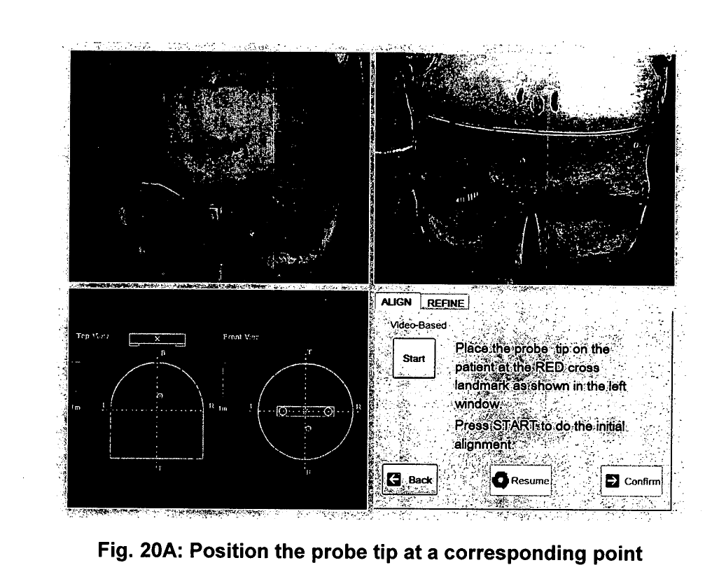

In exemplary embodiments of the present invention, the process of iterative closest point (ICP) measure can be implemented using the process flow depicted in FIG. 18. With reference thereto, at 1810, for each point in the real data, a nearest point in the model (virtual) data can be found. At 1820, for example, a transformation can be computed that shifts, as closely as possible, each of the points of the cloud point representation to the real point that was associated with it in its respective pair. Then, for example, at 1830, the computer can apply the transformation of 1820 to move the virtual model into closer alignment with the real object in the virtual coordinate system, and can then, for example, at the new location of the virtual model, compute a closeness metric between the real points and a new respective closest point for each of said real points in a cloud point representation at the new position. At 1840, for example, using a defined test or metric, it can be determined whether a termination condition has been met. In exemplary embodiments of the present invention, such a termination condition can be the error reaching or going below a certain maximum tolerable RMS error, or, for example, a certain defined number of iterations of the process having been performed, or for example, some combination of the two. At 1850, for example, if the termination condition has been met, process flow can end. If, at 1840, the termination condition has not been met, then process flow can, for example, return to 1810 and a further iteration can be performed.

Thus, in exemplary embodiments of the present invention, the overall registration process described above can be implemented using the following algorithm:
1) Adjust the viewpoint of the camera relative to the model;
2) Identify a pivot point in the model;
3) (The user starts doing the alignment) Display the model on the tip of the probe with the pose as computed in (1) (The pose of the object relative to the tip of the probe is now fixed);
4) Update the pose of the model based on the pose of the probe based on the computed tracking information;
5) (The user stops doing the alignment) Register the model at the final pose of the probe tip—initial registration has been done; and
6) Proceed with refinement registration (exemplary pseudocode for this refinement process has been described above), the output from this process is a transform that registers the virtual model data to the real point data, hence the real object.

It is noted that during the iterative steps in the refinement procedure, it can be faster to compute the registration that brings the real point data to the virtual model, (i.e., it is faster to compute the point pairs of the real point data (for example, 750)), than to compute the point pairs of the virtual model (which, in the head example described above, can be approximately 100,000 points). Therefore, the transformation that brings the real point data registered to the virtual model can be first computed during the iterative refinement step. The final transformation that brings the virtual model data to the real point data (the pose prior to the iterative refinement step, or just after the initial alignment step), hence the real object, is simply the inverse of the transformation that brings the real point data prior to the refinement step to the real point data after the refinement step.

Whilst the final position of the virtual model 100 may not be in exact alignment with the patient's head 10, it would most likely be in closer alignment than following the initial registration and thus be sufficiently aligned to be of assistance during, for example, surgery or other applications where image based guidance or navigation is needed.

Overall Process Flow

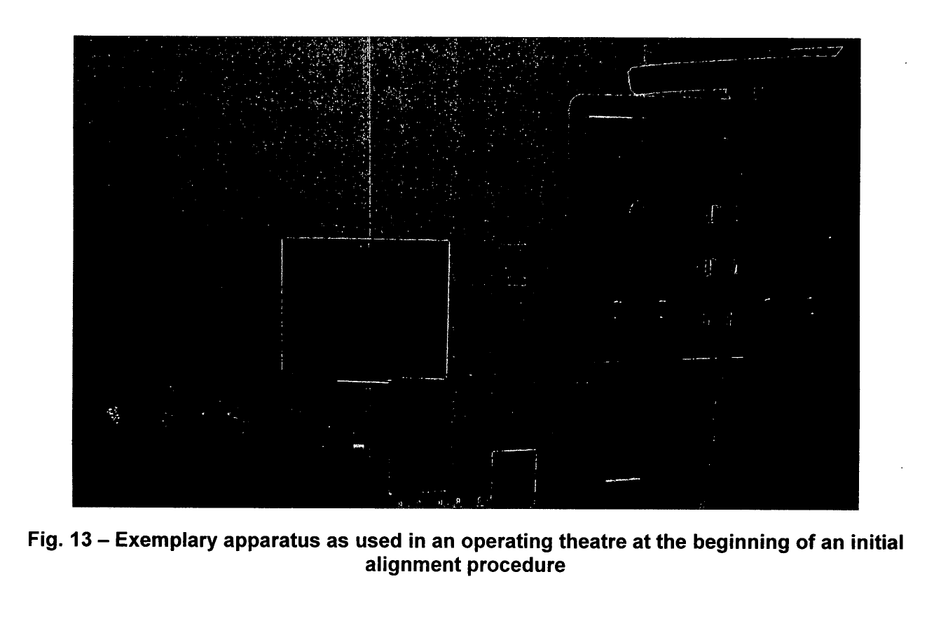

FIG. 10 depicts exemplary process flow for registration and navigation in exemplary embodiments according to the present invention. It is understood that such process flow can occur in an augmented reality system, or the like, having at least a computer, a tracking system, and a real time imaging system such as, for example, a video camera.

With reference to FIG. 10, at 1020, an initial registration can be performed, as described above, using various methods, such as are described herein. At 1010, for example, to implement a refined registration, real data can be collected, such as, for example 750 points on the surface of an object, as described above, and their positions input to a computer. Using the collected real data, and accessing virtual data 1015, representing a virtual model of the real object, at 1030, for example, a refined registration process can be implemented, as described above. Once the refined registration process has occurred, at 1040, for example, a user can confirm that the registration, as refined, is satisfactory. This can be done, for example, by visually evaluating the overlay error between the real image (e.g., from a video camera) and the virtual image from various viewpoints.

If the refined registration is satisfactory, navigation can begin.

The exemplary process flow of FIG. 10, can, for example, be implemented via a set of instructions executable by a computer. In such an implementation a user can, for example, be prompted to perform various acts to obtain needed inputs for the computer to perform its processing according to methods of exemplary embodiments of the present invention. Such an exemplary implementation can, for example, be a software module integrated with other software, such as, for example, navigation or surgical navigation software, and can be, for example, integrated with, or loaded on, an augmented reality system computer, or, for example, a surgical navigation system computer, such as is described in WO-A1-2005/000139. Further, such an exemplary implementation can have, for example, an interface by means of which a user interacts with an exemplary system to perform various registration processes according to exemplary embodiments of the present invention.

Such an exemplary software implementation is next described.

Exemplary Implementation

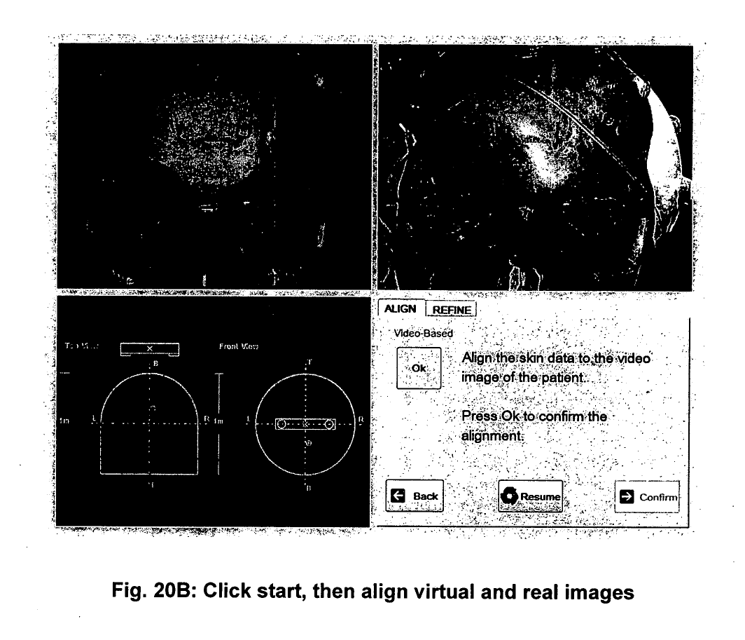

FIGS. 19 through 23 are screen shots of an exemplary system implementing an exemplary embodiment of the present invention. The screen shots depict an interface to the exemplary system that generated the images of FIGS. 11-17. The exemplary interface can guide a user through the initial and refined registration processes according to an exemplary embodiment of the present invention, as next described.

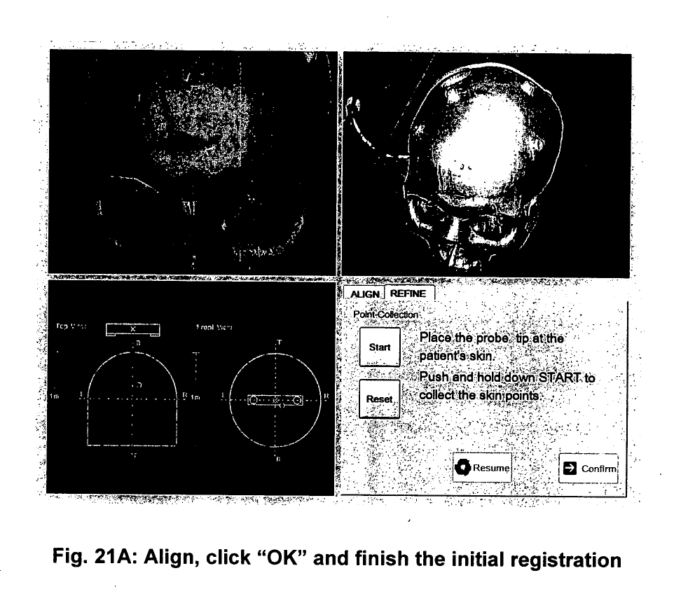

With reference to FIG. 19A, a screen prompts a user to load virtual data containing, for example, an MRI scan of a human head. This stores in a computer memory a virtual model. With reference to FIG. 19B, the user is then prompted to choose either video-based (augmented reality assisted) or landmark-based (fiducial) registration. In FIG. 19B it can be seen that the virtual image appearing at the upper left quadrant of FIG. 19B and the real phantom appearing at the upper right quadrant of FIG. 19B, do, in fact, have fiducials attached to them. However, according to exemplary embodiments of the present invention, registration need not be accomplished by acquiring the positions of these fiducials, thus dispensing with this cumbersome process. The depicted exemplary software simply offers both options. Therefore, a user would click on the tan/blue colored icon labeled “Video-Based” in the bottom right of FIG. 19B to select a “video-based” or non-fiducial based registration, and proceed to the next screen. Having done that, the user can, for example, be presented with a screen depicted in FIG. 20A (as can be seen in the bottom right quadrant thereof, the system indicates that it is implementing “Video-Based” alignment). As can also be seen in the bottom right quadrant of FIG. 20A, there is an initial alignment “ALIGN” selection tab (which is highlighted) as well as a “REFINE” alignment selection. FIG. 20 relate to the initial registration, as described above, which in the depicted embodiment of FIG. 20 is termed “ALIGN”. Thus, in FIG. 20A a user is prompted to place a probe tip on the patient (this is the real object, here the phantom head) at the point the user perceives as corresponding to the red-crossed landmark (the “+” icon) of the virtual model as shown in the upper left window of FIG. 20A, and to then press a start button to perform an initial alignment. This process is the anatomical landmark initial alignment process described above. It associates in the computer a correspondence between the virtual image and the real object at the chosen point, based on the assumption that the point indicated by the user on the real phantom corresponds to the point bearing the red cross in the virtual image. The fact that the points do not absolutely correspond, as noted above, can create registration, and thus overlay, error.

Continuing with reference to FIG. 20B, the user is prompted to align the “skin data” which is the virtual image, to the “video image”, which is the video image of the actual phantom head of the patient, by rotating or moving the camera probe until the virtual image and real image appear to be aligned. It is noted that the upper right quadrant of FIG. 20B shows the same image as is shown in FIG. 14, which is the initial status of the virtual image relative to the real image at the start of the initial alignment procedure, where the two images touch at the landmark point, but are not necessarily aligned.

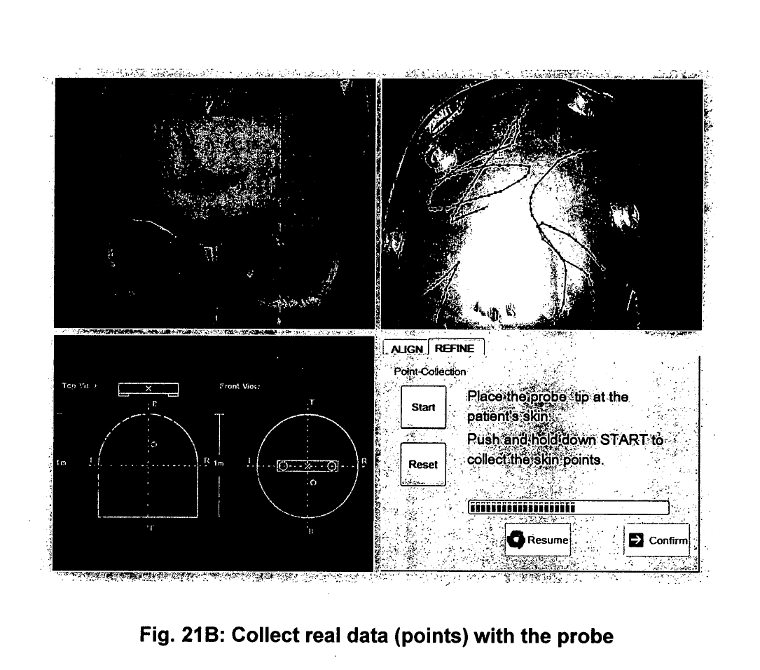

After the initial alignment prompted by FIG. 20B has been achieved, the user can press “OK” in the bottom right quadrant of FIG. 20B and can then be brought to the screen shown in FIG. 21A. At this point in the process, the bottom right quadrant of FIG. 21A no longer highlights the “ALIGN” selection, but rather the “REFINE” selection. This refers to the refined registration process described above which requires a number of real data points to be collected with the probe for further processing, such as, for example, with an ICP process. Thus, in FIG. 21A, as shown in the bottom right quadrant, the user is prompted to place the probe tip on the patient's skin (here the surface of the phantom head) and to press a “START” button to indicate to the system to begin collecting points on the phantom head's outer surface (i.e., record the 3-D location of the probe via the tracking system). As can be seen with reference to FIG. 21B (in particular, in the upper right quadrant of the figure), a number of real data points have been collected using the probe and the screen shot shows a situation in the middle of such points being collected, as is indicated by the white and green progress bar at the bottom of the bottom right quadrant of FIG. 21B.

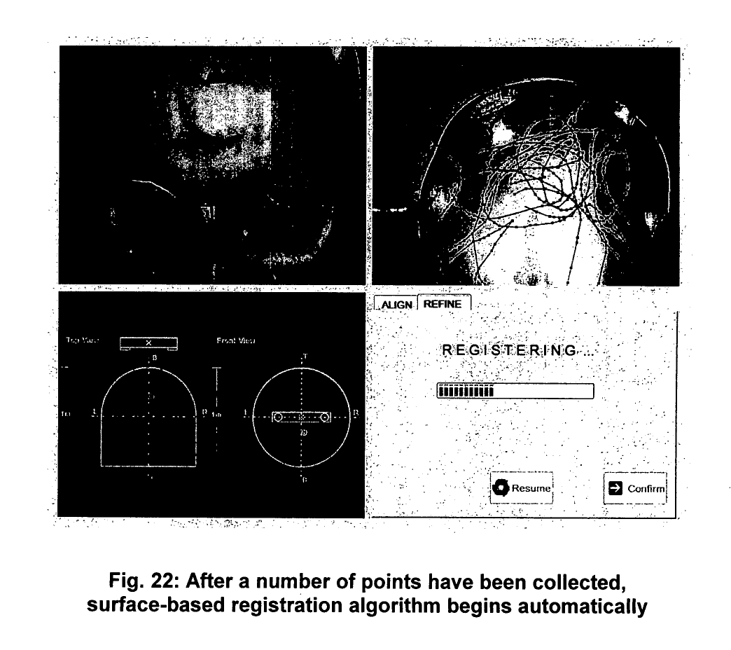

With reference to FIG. 22, after a sufficient number of points have been collected (which can be recognized by an exemplary system as equaling a certain defined number), a surface-based registration algorithm can automatically begin, as is shown in the bottom right quadrant of FIG. 22 where the system indicates that it is “REGISTERING . . . .” As can be seen in the top right quadrant of FIG. 22, there is some overlay error associated with the initial registration. The depicted overlay error is still the same as is shown in the upper right quadrant of FIG. 21A and FIG. 21B, respectively, that of the initial alignment.

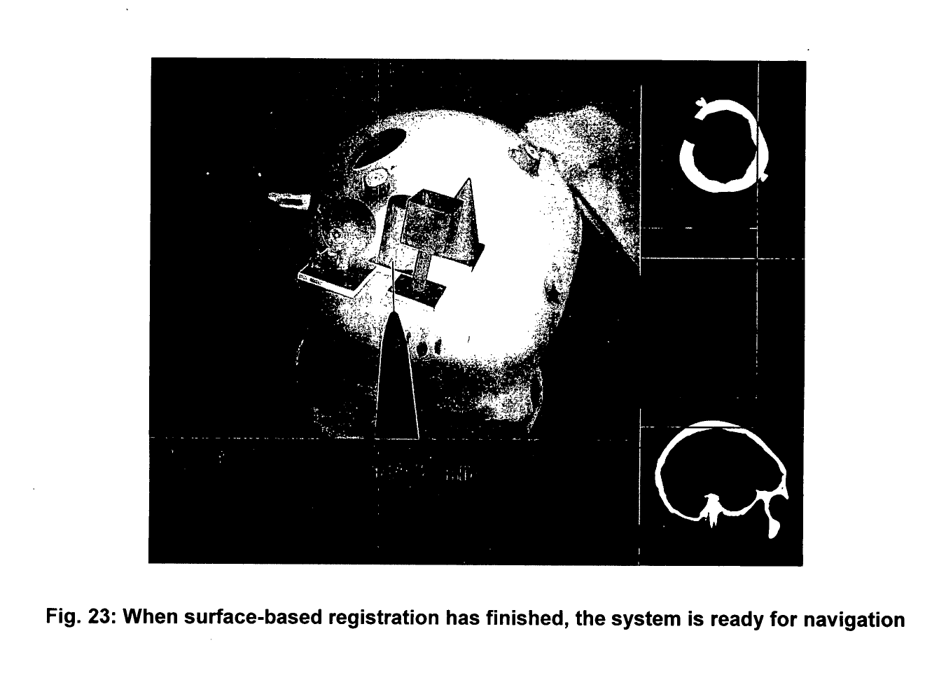

Once the registration algorithm has completed, as described above, including however many iterations are required to satisfy the termination condition, the augmented reality system is ready for use, such as, for example, for surgical navigation. An example of such a situation is depicted in FIG. 23 where the real image of the phantom is shown in the main viewing window and virtual reality images of interior contents of the phantom skull are shown in various colors. The virtual reality objects (all part of the virtual model) are depicted in positions relative to the real image determined by using the final iteration from the process depicted in FIG. 22. In FIG. 23, the virtual image of the outer surface of the skull is not shown, and the only virtual images are those of the interior objects (here in FIG. 23 shown as an aqua sphere, green cylinder, pink cube and blue cone, respectively, as shown in the figure beginning at the left of the phantom head and proceeding to approximately the center of it). The overlay error in FIG. 23 is essentially that of FIG. 17, a significant improvement over that of FIG. 21A (or of FIG. 15).

### Alternative Exemplary Embodiments

In alternative exemplary embodiments of the invention, an initial registration can be carried out in the manner described hereinabove up to the point at which the user depresses foot switch 65 indicating that camera probe 70 has been positioned on the patient's head and orientated such that the real images on the monitor 80 have been brought into substantial alignment with the image of the virtual model 100 thereon (initial registration) (all with reference to FIG. 5). In such alternative exemplary embodiments, the navigation software can, for example, react to the input from the foot switch 65 to freeze the real image of the head 10 on monitor 80. The navigation software of this alternative embodiment, as in the first embodiment described above, can also sense and record the position of real camera 72. With the real image of head 10 frozen, real camera 72 can then be put down. A user, for example, can then operate navigation station computer 60 to move the position of the virtual camera relative to the virtual model such that the image of virtual model 100 shown on the monitor 80 is shown from a different point of view (such manipulation can be done using appropriate commands being mapped to an interface of the navigation station computer, such as, via a mouse or various keystrokes). This can be done such that the image of the virtual model 100 shown on the monitor 80 is brought into closer alignment with the frozen real image of the head 10. In exemplary embodiments of the present invention, this alternative embodiment may be advantageous in that very fine movement of the virtual camera relative to the virtual model may be achieved (inasmuch as it is computer controlled and any desired dynamic range can be mapped to physical interface devices), whereas such fine movement of real camera 72 relative to head 10 (which is done by a user's hand motions) may be difficult. Thus, it may be possible to achieve a more accurate initial alignment in this alternative embodiment than is possible in the exemplary embodiment described above.

Once satisfactory alignment has been achieved, an input indicative of this can be provided to the navigation station computer such that the navigation software then proceeds with mapping the position of the virtual model 100 to position of the head 10 in the manner of the first embodiment.

In exemplary embodiments of the present invention, if the initial registration—as performed by either the first embodiment or the alternative embodiment as described hereinabove—results in an accuracy of alignment between the virtual model 100 and the real object 10 that is satisfactory for the intended subsequent procedures or given application, then the procedure of refined alignment described above may be omitted.

As noted above in connection with FIG. 10, to determine whether such refined registration is needed, for example, the accuracy of the registration may be assessed by moving the real camera around the head 10 to see whether or not there is apparent misalignment between virtual model 100 and head 10.

It is envisaged that the apparatus disclosed in each of WO-A1-02/100284 and WO-A1-2005/000139 may be modified in accordance with the foregoing description so as to amount to an exemplary embodiment of the apparatus described hereinabove and thereby to embody an example of the present invention. Accordingly, the contents of those two earlier publications are hereby incorporated herein in their entirety.

While this invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

What is claimed:

1. A method of mapping a model of an object, the model being a virtual model positioned in a virtual 3-D coordinate system in virtual space, substantially to the position of the object in a real 3-D coordinate system in real space, comprising:
a) computer processing means accessing information indicative of the virtual model;
b) the computer processing means displaying on video display means a virtual image that is a view of at least part of the virtual model, the view being as if from a virtual camera fixed in the virtual coordinate system; and also displaying on the display means real video images of the real space captured by a real video camera moveable in the real coordinate system; wherein the real video images of the object at a distance from the camera in the real coordinate system are shown on the display means as being substantially the same size as the virtual image of the virtual model when the virtual model is at that same distance from the virtual camera in the virtual coordinate system;
c) the computer processing means receiving an input indicative of the camera having been moved in the real coordinate system into a position in which the display means shows the virtual image of the virtual model in virtual space to be substantially coincident with the real video images of the object in real space;
d) the computer processing means communicating with sensing means to sense the position of the camera in the real coordinate system;
e) the computer processing means accessing model position information indicative of the position of the virtual model relative to the virtual camera in the virtual coordinate system;
f) the computer processing means responding to the input to ascertain the position of the object in the real coordinate system from the sensed position of the camera sense in step (d) and the model position information of step (e); and then mapping the position of the virtual model in the virtual coordinate system substantially to the position of the object in the real coordinate system.

2. A method according to claim 1 including the subsequent step of applying the mapping to position at least one of the virtual model and the object such that they are substantially coincident in one of the coordinate systems.

3. A method according to claim 1, wherein the mapping includes generating a transform that maps the position of the virtual model to the position of the object and the method includes the subsequent step of applying the transform to position the object in the virtual coordinate system so as to be substantially coincident with the virtual model in the virtual coordinate system.

4. A method according to claim 1, wherein the mapping includes generating a transform that maps the position of the virtual model to the position of the object and the method includes the subsequent step of applying the transform to position the virtual model in the real coordinate system so as to be substantially coincident with the object in the real coordinate system.

5. A method according to an preceding claim and including the step of positioning the virtual model relative to the virtual camera in the virtual coordinate system so as to be a predefined distance from the virtual camera.

6. A method according to claim 5, wherein the step of positioning the virtual model also includes the step of orientating the virtual model relative to the virtual camera.

7. A method according to claim 5, wherein the positioning step includes selecting a preferred point of the virtual model and positioning the virtual model relative to the virtual camera such that the preferred point is at the predefined distance from the virtual camera.

8. A method according to claim 7, wherein the preferred point substantially coincides with a well-defined point on the surface of the object.

9. A method according to claim 6, wherein the orientating step includes orientating the virtual model such that the preferred point is viewed by the virtual camera from a preferred direction.

10. A method according to claim 7, wherein a user specifies a preferred point of the virtual model.

11. A method according to claim 5, wherein a user specifies a preferred direction from which the preferred point is viewed by the virtual camera.

12. A method according to claim 5, wherein the virtual model and/or the virtual camera are automatically positioned such that the distance there between is the predefined distance.

13. A method according to any preceding claim and including the subsequent step of displaying on the video display means real images of the real space captured by the real camera, and virtual images of the virtual space as if captured by the virtual camera, the virtual camera being moveable in the virtual space with movement of the real camera in the real space such that the virtual camera is positioned relative to the virtual model in the virtual coordinate system in the same way as the real camera is positioned relative to the object in the real coordinate system.

14. A method according to claim 13, and including the steps of: the computer processing means communicating with the sensing means to sense the position of the camera in the real coordinate system; the computer processing means then ascertaining therefrom the position of the real camera relative to the object; and the computer processing means displaying a virtual image on the display means as if the virtual camera has been moved in the virtual coordinate system so as to be at the same position relative to the virtual model.

15. Mapping apparatus for mapping a model of an object, the model being a virtual model positioned in a virtual 3-D coordinate system in virtual space, substantially to the position of the object in a real 3-D coordinate system in real space; wherein the apparatus includes computer processing means, a video camera and video display means;
the apparatus arranged such that: the video display means is operable to display real video images captured by the camera of the real space, the camera being moveable within the real coordinate system; and the computer processing means is operable to display also on the video display means a virtual image that is a view of at least part of the virtual model, the view being as if from a virtual camera fixed in the virtual coordinate system,
wherein the apparatus further includes sensing means to sense the position of the video camera in the real coordinate system and to communicate camera position information indicative of this to the computer processing means, and the computer processing means is arranged to access model position information indicative of the position of the virtual model relative to the virtual camera in the virtual coordinate system and to ascertain from the camera position information and the model position information the position of the object in the real coordinate system, and
wherein the computer processing means is arranged to respond to an input indicative of the camera having been moved in the real coordinate system into a position in which the video display means shows the virtual image of the virtual model in virtual space to be substantially coincident with a real video image of the object in real space by mapping the position of the virtual model in the virtual coordinate system substantially to the position of the object in the real coordinate system.

16. Apparatus according to claim 13, wherein the computer processing means is arranged and programmed to carry out a method according to claim 1.

17. Apparatus according to claim 13, wherein the camera is of a size and weight such that it can be held in the hand of a user and thereby moved by the user.

18. Apparatus according to claim 15, wherein the real camera includes a guide fixed thereto and arranged such that when real camera is moved such that the guide contacts the surface of the object, the object is at a predefined distance from the real camera that is known to the computer processing means.

19. Apparatus according to claim 18, wherein the guide is an elongate probe that projects in front of the real camera.

20. Apparatus according to any one of claim 15, wherein the specification and arrangement of the real camera are such that the real video images of the object at the distance from the camera in the real coordinate system are shown on the display means as being substantially the same size as the virtual image of the virtual model when the model is at that same distance from the virtual camera in the virtual coordinate system

21. Apparatus according to claim 15, wherein the computer processing means is programmed such that the virtual camera has the same optical characteristics as the real camera such the real video images of the object at the distance from the camera in the real coordinate system are shown on the display means as being substantially the same size as the virtual image of the virtual model when the model is at that same distance from the virtual camera in the virtual coordinate system.

22. Apparatus according to claim 15 and including input means operable by the user to provide the input indicative of the camera having been the position in which the video display means shows the virtual image of the virtual model to be substantially coincident with the real image of the object.

23. Apparatus according to claim 22, wherein the input means includes a user-operated switch that can be placed on the floor and operated by the foot of a user.

24. A method of more closely aligning a model of an object, the model being a virtual model positioned in a 3-D coordinate system in space, with the object in the coordinate system, the virtual model and the object having already been substantially aligned, the method including the steps of:
a) computer processing means receiving an input indicating that a real data collection procedure should begin;
b) the computer processing means communicating with sensing means to ascertain the position of a probe in the coordinate system, and thereby the position of a point on the surface of the object when the probe is in contact with that surface;
c) the computer processing means responding to the input to record automatically and at intervals respective real data indicative of each of a plurality of positions of the probe in the coordinate system, and hence indicative of each of a plurality of points on the surface of the object when the probe is in contact with that surface;
d) the computer processing means calculating a transform that substantially maps the virtual model to the real data.
e) the computer processing means applying the transform to more closely align the virtual model with the object in the coordinate system.

25. A method according to claim 24, wherein, at step (c), the method records respective real data indicative of each of positions of the probe.

26. A method according to claim 23, wherein the computer processing means automatically records the respective real data such that the position of the probe at periodic intervals is recorded.

27. A method according to claim 24 and including the step of the computer processing means displaying on video display means one more or all of the positions of the probe for which real data is recorded.

28. A method according to claim 27 and including displaying the positions of the probe together with the virtual image of the virtual model on the video display means to show the relative positions thereof in the coordinate system.

29. A method according to claim 27, wherein each position of the probe is displayed in real time.

30. Computer processing means arranged and programmed to carry out a method according to claim 1.

31. Computer processing means arranged and programmed to carry out a method according to claim 24.

32. A computer program including code portions which are executable by computer processing means to cause those means to carry a method according to claim 1.

33. A computer program including code portions which are executable by computer processing means to cause those means to carry a method according to claim 24.

34. A record carrier including therein a record of a computer program having code portions which are executable by computer processing means to cause those means to carry out a method according to claim 1.

35. A record carrier including therein a record of a computer program having code portions which are executable by computer processing means to cause those means to carry out a method according to claim 24.

36. A record carrier according to claim 34, wherein the record carrier is one of a computer readable record product and a signal transmitted over a network.

37. A record carrier according to claim 35, wherein the record carrier is one of a computer readable record product and a signal transmitted over a network.

38. A method of registering a virtual model of a real object with the real object, comprising:
performing an initial registration between the virtual model and the real object; and
subsequently performing a refined registration between the virtual model and the real object,
wherein the initial registration includes visually aligning an image of the virtual model of the object displayed on a display with a real-time image of the real object displayed on the display by causing one of the images to translate and or rotate relative to the other one, and
wherein the refined registration includes acquiring the locations of a defined number of points on a surface of the real object, using those points and a set of respective corresponding points in the virtual model to find an overall best fit between said real points and said respective corresponding virtual points, and generating a transformation of the virtual model to the real object based upon said best fit.

39. The method of claim 38, wherein the virtual model is generated from an imaging scan.

40. The method of claim 38, wherein the virtual model is stored in a computer.

41. The method of claim 38, wherein the positions of the real object and a probe are tracked by a tracking system.

42. The method of claim 41, wherein the real-time image of the real object is acquired by a camera integrated with the probe.

43. The method of claim 41, wherein, in performing the refined registration, the locations of the points on the surface of the real object are acquired by recording various locations of the probe via the tracking system and communicating them to a computer.

44. The method of claim 38, wherein the best fit between the acquired points on the surface of the real object and their respective corresponding points in the virtual model is obtained using an iterative closest point analysis.

45. The method of claim 44, where the iterative closest point analysis can be repeated by shifting the virtual model based upon the generated transformation, obtaining a new set of respective corresponding points in the virtual model to find a new overall best fit between said real points and said respective corresponding virtual points, and generating a new transformation of the virtual model to the real object based upon said best fit.

46. A computer program product comprising a computer usable medium having computer readable program code means embodied therein, the computer readable program code means in said computer program product comprising means for causing a computer to:
perform an initial registration between the virtual model and the real object; and
subsequently perform a refined registration between the virtual model and the real object,
wherein the initial registration includes visually aligning an image of the virtual model of the object displayed on a display with a real-time image of the real object displayed on the display by causing one of the images to translate and or rotate relative to the other one, and
wherein the refined registration includes acquiring the locations of a defined number of points on a surface of the real object, using those points and a set of respective corresponding points in the virtual model to find an overall best fit between said real points and said respective corresponding virtual points, and generating a transformation of the virtual model to the real object based upon said best fit.

47. The computer program product of claim 46, wherein the virtual model is generated from an imaging scan.

48. The computer program product of claim 46, wherein the virtual model is stored in a computer.

49. The computer program product of claim 46, wherein the positions of the real object and a probe are tracked by a tracking system.

50. The computer program product of claim 49, wherein the real-time image of the real object is acquired by a camera integrated with the probe.

51. The computer program product of claim 49, wherein, in performing the refined registration, the locations of the points on the surface of the real object are acquired by recording various locations of the probe via the tracking system and communicating them to a computer.

52. The computer program product of claim 46, wherein the best fit between the acquired points on the surface of the real object and their respective corresponding points in the virtual model is obtained using an iterative closest point analysis.

53. The computer program product of claim 52, where the iterative closest point analysis can be repeated by shifting the virtual model based upon the generated transformation, obtaining a new set of respective corresponding points in the virtual model to find a new overall best fit between said real points and said new respective corresponding virtual points, and generating a new transformation of the virtual model to the real object based upon said best fit.

54. The computer program product of claim 46, the computer readable program code means in said computer program product further comprising means for causing a computer to:
generate a user interface that guides a user to perform the initial registration and the refined registration, wherein said user interface prompts the user to acquire data and advises the user when each of the initial and refined registrations have completed.

55. A system for registering a virtual model of a real object with the real object, comprising:
at least one computer;
a memory arranged to store a virtual model of a real object;
a display;
a probe with an integrated camera; and
a tracking system,
wherein, in operation, real images of the real object acquired by the camera and a virtual image of the virtual model are displayed on the display in a combined image, and wherein a user performs a first registration by aligning a real image with the virtual image, and a refined registration by moving the probe over the surface of the real object to acquire the locations of a set of points, and wherein the computer associates the set of real points with corresponding respective closest points in the virtual model, and uses the real points and the corresponding respective closest points to find an overall best fit between said real points and said corresponding respective virtual points, and generates a transformation of the virtual model to the real object based upon said best fit.

56. The system of claim 55, wherein after implementing the transformation the computer repeats the processes of associating the set of real points with corresponding respective closest points in the virtual model, using the real points and the corresponding respective closest points to find an overall best fit between said real points and said corresponding respective virtual points, and generating a transformation of the virtual model to the real object based upon said best fit until a defined condition has occurred.

57. The system of claim 56, wherein the computer is loaded with the computer program product of claim 46.

58. The system of claim 56, wherein the computer is loaded with the computer program product of claim 54.
